(19) United States
(12) Patent Application Publication
(10) Pub. No.: US 2019/0054437 A1
(43) Pub. Date: Feb. 21, 2019

(54) Mechanisms and Methods for Mixing and/or Dispensing Multipart Materials

(71) Applicant: Ryan R. HOPKINS, Reno, Nevada, AZ (US)

(72) Inventor: Ryan R. HOPKINS, Reno, Nevada, AZ (US)

(21) Appl. No.: 16/080,832

(22) PCT Filed: Feb. 24, 2017
(86) PCT No.: PCT/US2017/019435

§ 371 Date: Aug. 29, 2018

Related U.S. Application Data
(60) Provisional application No. 62/301,324, filed on Feb. 29, 2016.

(51) Int. Cl. B01F 15/02; B01F 5/06; B01F 7/00; B29B 7/72; B29B 7/74; B29B 7/80

(52) U.S. Cl. CPC B01F 15/0267; B01F 15/027; B01F 5/0615; B01F 7/00425; B01F 2215/0039; B29B 7/7442; B29B 7/7447; B29B 7/7457; B29B 7/801; B29B 7/728

(57) ABSTRACT

Methods and mechanisms for mixing and dispensing multipart materials is provided. The methods and mechanisms may be used for mix on demand operations as well as for encapsulation of electronic components. The methods and mechanisms may incorporate a mixer assembly from which material is substantially directly dispensed. The methods and mechanisms may incorporate mix on demand where first and second material supply sources include pumping arrangements for pumping first and second materials through a mixing arrangement. The pumping forces provided by the pumping arrangements also provide the force to dispense the mixed material where it will ultimately be formed, such as a potting location or a mold.

### FIELD OF THE INVENTION

This invention generally relates to dispensing of multi-part materials formed from a mixture of multiple materials, and more particularly to the use of static mixers for mixing the material prior to being dispensed.

### BACKGROUND OF THE INVENTION

Static mixers can be used to mix a plurality of different materials to form a mixed material that can then be used for various activities. For instance, the mixed material could be used in a molding system for molding desired components. Alternatively, the material could be dispensed directly into other components such as a multi-part material potting process. Unfortunately, the mixed material may often cure in the static mixer leading to significant downtime or expense to have the mixer of the dispensing system cleaned or replaced.

Another problem with static mixers is that the static mixers do not incorporate a shut-off at the point where the mixed material is exiting the system. This can often result in material dripping and leaking from the exit port of the nozzle which requires additional cleanup or can result in inaccurate metering of the mixed material. This can also result in the undesirable waste of product. This is particularly true when processing low viscosity materials where merely the force of gravity is sufficient to cause material to drip from the tip of the nozzle resulting in dripping or drooling material. This problem is also true when utilizing highly viscous materials where compression of the material is a factor. The viscous compressible material will require pressure to push the material through the static mixer. However, when the pressure is removed after dispensing, the compressible material will expand to a pre-compressed state causing the material to drip from the system. Additionally, in an open static mixer, the material must be maintained with some back pressure which, without the shut-off, allows the material to leak from the static mixer due to the back pressure.

Other problems exist when using mixed multi-part materials for electronic encapsulation. Electronic encapsulation is typically done using potting or low pressure injection molding methods. Potting processes typically have long cycle times (30 minutes to 48 hours), involve a secondary curing process (which can expose the electronic components such as a printed circuit board (PCB) to elevated temperatures for prolonged periods of time), and are prone to have waste material from the mixing process. Low pressure injection molding processes have fast cycle times (from 20 seconds to 2 minutes), but have been limited to only a handful of low viscosity thermoplastic materials (typically hotmelt adhesive type materials with viscosity ranges between 1,500 cPs and 10,000 cPs). The thermoplastic materials expose the PCBs to thermal shock with the material being injected around the substrate at temperatures ranging from 380 deg. F. to 450 deg. F. with pressures ranging from 50 psi to 2000 psi.

The traditional thermoplastic materials used in low pressure molding, polyamides, are susceptible to chemical degradation, and the low viscosity polyolefins are typically too soft (Shore A 50 to 65) with very little elasticity and a poor memory. Low viscosity co-polyesters (viscosities range between 7,500 cPs and 50,000 cPs) have acceptable chemical resistance, but they undergo rapid material degradation when held at the molten temperature required for the injection molding process for times exceeding 30 minutes, and they also require higher injection pressures and have higher manufacturing costs than many other materials.

Introducing new chemistries for molding processes requires different machine designs and functionality. Traditional low pressure over molding machines use a hot melt reservoir coupled with a high temperature gear pump or the machines use a screw and barrel delivery similar to extrusion processing equipment.

There are encapsulation methods where molds are manufactured out of Silicone or Teflon and the part is placed inside of the cavity of the mold, and a resin is dispensed into the mold around the part. The resins used in this process are typically heat cure, moisture cure, or time cure chemistries. The heat cure process can be used, but the nature of the process requires large amounts of time (more than 1 hour), and the process is not precise and often has a long processing time making it difficult for large volume production.

As such, the current state of the art suffers from poor cycle times, and/or poor material quality or resistance to degradation, low precision, and undesirable amounts of waste and/or mess.

### BRIEF SUMMARY OF THE INVENTION

In one embodiment, a mixer assembly is provided. The mixer assembly includes a mixer housing tube extending axially between an inlet end and an outlet end. The mixer housing tube defines an internal cavity. The outlet end of the mixer housing tube has an outlet port defining a sealing surface. The outlet port fluidly communicating the internal cavity with the exterior of the mixer housing tube. The mixer assembly includes a shut-off pin within the mixer housing tube. The shut-off pin is selectively moveable between an open position and a closed position. The shut-off pin cooperates with the sealing surface of the outlet port to close the outlet port in the closed position. The shut-off pin is spaced from the sealing surface of the outlet port in the open position to permit fluid flow through the outlet port. The mixer assembly includes a material manifold proximate the inlet end of the mixer housing tube including a first material inlet in fluid communication with the internal cavity and a second material inlet in fluid communication with the internal cavity. The mixer assembly includes a mixer element located within the internal cavity of the mixer housing tube between the outlet port and the material manifold, the mixer element forming a mixing passage fluidly connecting the first and second material inlets with the outlet port.

In one embodiment, the shut-off pin extends through the mixer element.

In one embodiment, the mixer element causes a first fluid flowing from the first material inlet to the outlet port and a second fluid flowing from the second material inlet to the outlet port to mix together.

In one embodiment, the shut-off pin includes a connection head configured to be releasably connected to an actuator for actuation of the shut-off pin between the closed and open positions.

In one embodiment, the shut-off pin extends through the material manifold and is externally engageable by the actuator.

In one embodiment, the mixer housing tube, shut-off pin, material manifold and mixer element form a disposable unit.

In one embodiment, the first material inlet includes a coupling for operably releasably connecting to a source of a first material and the second material inlet includes a coupling for operably releasably connecting to a source of a second material. The shut-off pin includes a connection element configured to releasably connect to an actuator for actuating the shut-off pin between the closed and open positions.

In one embodiment, the mixer element extends axially along a longitudinal axis between a first end and a second end. The first end of the mixer element is positioned proximate the material manifold and the second end of the mixer element is positioned proximate the outlet port. The mixer housing internal cavity includes a mixing region and a dispensing region downstream of and fluidly connected with the mixing region. The mixer element is located in the mixing region, the dispensing region includes the outlet port. The shut-off pin extends through the dispensing region and moves between the open and closed positions along a shut-off pin axis that is non-parallel to the longitudinal axis of the mixer element and is co-axial with the outlet port.

In one embodiment, the shut-off pin is spring biased in a direction extending from the open position towards the closed position.

In one embodiment, the mixer element is a static mixer and is prevented from rotating within the mixer housing tube.

In one embodiment, the shut-off pin and mixer element are formed as a single component and the mixer element moves when the shut-off pin moves between the open and closed positions.

In one embodiment, the mixer element is a dynamic mixer and is rotatably mounted within the mixer housing tube to rotate about an axis of rotation.

In one embodiment, a driven gear is mechanically coupled to the mixer element to transfer rotational motion of the driven gear to the mixer element.

In an embodiment, a multiple material dispensing system is provided. The multiple material dispensing system includes a first mixer assembly as described above. The multiple material dispensing system includes a mixer holding arrangement defining a mixer holding cavity in which the first mixer assembly is mounted. The multiple material dispensing system includes an actuator releasably connected to the shut-off pin for actuation of the shut-off pin between the open and closed positions. The multiple material dispensing system includes a source of a first material operably releasably connected to the first material inlet. The multiple material dispensing system includes a source of a second material operably releasably connected to the first material inlet.

In one embodiment, the mixer element, the mixer housing tube and shut-off pin are removeable from the mixer holding arrangement as a complete unit.

In one embodiment, the mixer element, the mixer housing tube, the material manifold and shut-off pin are removeable from the mixer holding arrangement as a complete unit.

In one embodiment, the mixer holding arrangement is a holding body defining at least one heat transfer passage therethrough configured to flow a cooling or heating liquid to provide heat to or remove heat from the mixer element while material is dispensed therefrom.

In one embodiment, the mixer holding arrangement includes a first holding body portion, a second holding body portion and a nozzle. The nozzle and second holding body portion are releasably attached to the first holding body portion to allow for removal of the first mixer assembly from the mixer holding cavity.

In one embodiment, the first holding body portion, the second holding body portion and the nozzle define, at least in part, the mixer holding cavity.

In one embodiment, fluid exiting the first mixer assembly outlet port exits the mixer holding arrangement through the nozzle.

In one embodiment, the system further includes a mold defining a mold port. The nozzle is configured to mate with the mold port when material is injected into the mold from the mixer assembly.

In one embodiment, the mixer element is configured to mix a first material supplied by the source of a first material with a second material supplied by the source of a second material to form a mixed material prior to exiting the outlet port of the mixer assembly.

In one embodiment, the mixer holding arrangement includes a first holding body portion and a second holding body portion. The second holding body portion is releasably attached to the holding body to allow for removal of the mixer assembly from the mixer holding cavity. At least a portion of the mixer housing tube including the outlet port extends out of the mixer holding cavity.

In one embodiment, the system includes a second mixer assembly. The first and second mixer assemblies being disposable while the mixer holding arrangement, actuator, source of a first material, and source of a second material are reusable components.

In one embodiment, the source of the first material and the source of the second material are maintained under positive pressure.

In one embodiment, the system includes a second actuator operably coupled to the mixer element for rotationally driving the mixer element within the mixer housing tube.

In one embodiment, the system is a mix on demand system. The pumping force for forcing the first and second materials from the source of a first material, the source of a second material, through the material manifold, and through the outlet port is provided by the first and second sources of material.

In one embodiment, rotational motion of the mixer element provides a net zero pumping force for moving the first and second materials and mixed material through the mixer element.

In one embodiment, the system includes a mold set that cooperates with the first mixer assembly. The mold set defining a mold cavity. The pumping force for dispensing mixed material into the mold cavity is provided by the first and second sources of material.

In one embodiment, the shut-off pin and mixer element are co-axial and the mixer element rotates about a longitudinal axis along which the shut-off pin is driven between the open and closed positions.

In one embodiment, a method of dispensing a multi-component material from a multiple material dispensing system is provided. The method includes supplying a first material from a source of a first material to a first mixer assembly. The method includes supplying a second material from a source of a second to the first mixer assembly. The method includes mixing the first and second materials with the first mixer assembly to form a mixed material. The method includes dispensing the mixed material from the first mixer assembly through an outlet port of the first mixer assembly. The method includes actuating a shut-off pin of the first mixer assembly between an open position and a closed position. The shut-off pin cooperates with a sealing surface of the outlet port to close the outlet port in the closed position. The shut-off pin is spaced from the sealing surface of the outlet port in the open position to permit fluid flow through the outlet port.

In one embodiment, the method includes replacing the first mixer assembly with a second mixer assembly.

In one embodiment, each of the first and second the mixer assemblies further includes a mixer housing tube, a material manifold and a mixer element. The mixer housing tube extends axially between an inlet end and an outlet end. The mixer housing tube defines an internal cavity, the outlet end of the mixer housing tube including the outlet port. The outlet port fluidly communicates the internal cavity with the exterior of the mixer housing tube. The shut-off pin is within the mixer housing tube. The material manifold is proximate the inlet end of the mixer housing tube and includes a first material inlet in fluid communication with the internal cavity and a second material inlet in fluid communication with the internal cavity. A mixer element is located within the internal cavity of the mixer housing tube between the outlet port and the material manifold. The mixer element forms a mixing passage (in combination with the mixer housing tube) fluidly connecting the first and second material inlets with the outlet port.

In one embodiment, the multiple material dispensing system includes a mixer holding arrangement defining a mixer holding cavity in which the first mixer assembly is mounted. The multiple material dispensing system includes an actuator releasably connected to the shut-off pin for actuation of the shut-off pin between the open and closed positions. The multiple material dispensing system includes a source of a first material operably releasably connected to the first material inlet. The multiple material dispensing system includes a source of a second material operably releasably connected to the first material inlet. The step of replacing the first mixer assembly with the second mixer assembly includes removing and replacing the mixer housing tube, material manifold, shut-off pin and mixer element of the first mixer assembly from the mixer holding arrangement as a single unit.

In one embodiment, each of the first and second the mixer assemblies includes a mixer housing tube extending axially between an inlet end and an outlet end. The mixer housing tube defines an internal cavity. The outlet end of the mixer housing tube includes the outlet port. The outlet port fluidly communicates the internal cavity with the exterior of the mixer housing tube. The shut-off pin is within the mixer housing tube. Each of the first and second the mixer assemblies includes a mixer element located within the internal cavity of the mixer housing tube between the outlet port and the source of the first material and the source of the second material. The mixer element forms, at least in part, a mixing passage fluidly connecting the source of the first material and the source of the second material with the outlet port.

In one embodiment, the multiple material dispensing system includes a mixer holding arrangement defining a mixer holding cavity in which the first mixer assembly is mounted. The multiple material dispensing system includes a material manifold located within the mixer holding cavity and attached proximate the inlet end of the mixer housing tube. The material manifold includes a first material inlet in fluid communication with the internal cavity and a second material inlet in fluid communication with the internal cavity. The multiple material dispensing system includes an actuator releasably connected to the shut-off pin for actuation of the shut-off pin between the open and closed positions. The multiple material dispensing system includes source of a first material operably releasably connected to the first material inlet. The multiple material dispensing system includes a source of a second material operably releasably connected to the first material inlet. The step of replacing the first mixer assembly with the second mixer assembly includes removing and replacing the mixer housing tube, shut-off pin and mixer element of the first mixer assembly from the mixer holding arrangement as a single unit. The material manifold is reusable with the second mixer assembly.

In one embodiment, the method includes cooling the mixer element during the step of mixing the first and second materials with the first mixer assembly to form a mixed material.

In one embodiment, the method includes comprising heating the mixed material after the mixed material has been dispensed from the first mixer assembly.

In one embodiment, the step of dispensing the mixed material includes dispensing the mixed material into a cavity of a mold. The step of heating the mixed material is performed on the mixed material within the cavity of the mold promoting curing of the mixed material.

In one embodiment, the step of dispensing the mixed material includes dispensing the mixed material into a cavity of a mold, the method further comprising disengaging the mixer assembly from the mold to inhibit thermal transfer between the mold and the mixer element.

In one embodiment, the first and second materials are components of a liquid silicone rubber and the mixed material is a liquid silicone rubber material.

In one embodiment, the step of dispensing the mixed material includes dispensing the mixed material into a cavity of a mold.

In one embodiment, the method includes locating an electronic component within the mold and dispensing the mixed material into the cavity of the mold includes encapsulating at least a portion of the electronic component with the mixed material.

In one embodiment, a cycle time is less than 5 minutes.

In one embodiment, dispensing the mixed material into the cavity of mold reaches a pressure of at least 0.5 psi.

In one embodiment, the first and second materials are parts of a thermoplastic material and the mixed material is a thermoplastic material.

In one embodiment, the first and second materials are parts of a polyurea material and the mixed material is a polyurea material.

In one embodiment, the first mixer assembly further includes a mixer housing tube extending axially between an inlet end and an outlet end. The mixer housing tube defines an internal cavity. The outlet end of the mixer housing tube includes the outlet port. The outlet port fluidly communicates the internal cavity with the exterior of the mixer housing tube. The shut-off pin is within the mixer housing tube. A material manifold is proximate the inlet end of the mixer housing tube and includes a first material inlet in fluid communication with the internal cavity and a second material inlet in fluid communication with the internal cavity. A mixer element is located within the internal cavity of the mixer housing tube between the outlet port and the material manifold. The mixer element and mixer housing tube forming a mixing passage fluidly connecting the first and second material inlets with the outlet port. The method further including rotating the mixer element within the housing tube.

In one embodiment, the shut-off pin is actuated along a longitudinal axis and the mixer element is rotated about the longitudinal axis.

In one embodiment, the shut-off pin is actuated along a longitudinal axis and the mixer element is rotated about a rotational axis that is non-parallel to the longitudinal axis.

In an embodiment, a mix on demand multiple material dispensing system is provided. The system includes a first mixer assembly a source of a first material and a source of a second material. The first mixer assembly includes a mixer housing tube, a material manifold and a mixer element. The mixer housing tube extends axially between an inlet end and an outlet end. The mixer housing tube defines an internal cavity. The outlet end of the mixer housing tube has an outlet port. The outlet port fluidly communicates the internal cavity with the exterior of the mixer housing tube. The material manifold is proximate the inlet end of the mixer housing tube and includes a first material inlet in fluid communication with the internal cavity and a second material inlet in fluid communication with the internal cavity. The mixer element is located within the internal cavity of the mixer housing tube between the outlet port and the material manifold. The mixer element forms a mixing passage fluidly connecting the first and second material inlets with the outlet port for mixing fluids flowing from the first and second material inlets to the outlet port. The source of a first material includes a first storage reservoir for holding a first material. The source of a first material includes a first pumping assembly operably connected to the first material inlet and configured to pump a first material into the first material inlet. The source of a second material includes a second storage reservoir for holding a first material. The source of a second material includes a second pumping assembly operably connected to the second material inlet and configured to pump a second material into the second material inlet. The first and second pumping assemblies pump the first and second materials into and through the material manifold and through the mixer element.

In one embodiment, the system includes a mold defining a mold cavity in fluid communication with the outlet port of the mixer assembly. The first and second pumping assemblies pump the first and second materials into the material manifold through the mixer element and into the mold cavity.

In one embodiment, a distance from the location where the first and second material inlets communicate with the internal cavity to the outlet port is less than 36 inches.

In one embodiment, the system includes a first heat transfer unit cooperating with the first mixer assembly to control the temperature of the first mixer assembly.

In one embodiment, the system includes a first heat transfer unit cooperating with the first mixer assembly to control a temperature of the first mixer assembly and a second heat transfer unit cooperating with the mold to control a temperature of the mold.

In one embodiment, the system includes a shut-off pin within the mixer housing tube. The shut-off pin is selectively moveable between an open position and a closed position. The shut-off pin cooperates with the sealing surface of the outlet port to close the outlet port in the closed position. The shut-off pin is spaced from the sealing surface of the outlet port in the open position to permit fluid flow through the outlet port.

In one embodiment, the system includes a mold defining a mold cavity in fluid communication with the outlet port of the mixer assembly. The first and second pumping assemblies pump the first and second materials into the material manifold, through the mixer element and into the mold cavity. The system further includes an actuation arrangement configured to selectively engage and disengage the mixer assembly from the mold to reduce heat transfer between the mold and the mixer assembly.

In one embodiment, the first mixer assembly, the first pumping assembly and second pumping assemblies are configured such that the mixed materials having viscosities of between 150 and 1,000,000 cPs can be mixed and dispensed.

In one embodiment, the mold is configured to hold an electronic component to be encapsulated by the mixed material such that the system is a multi-part electronic encapsulation system.

In one embodiment, the mold includes retractable locating features for holding the electronic component within the mold cavity. The retractable locating features re retractable from the mold cavity after a sufficient amount of mixed material is dispensed into the mold cavity such that an area occupied by the retractable locating features can be filled with mixed material.

In one embodiment, the system further includes an actuator coupled to the mixer element to rotate the mixer element within the mixer housing tube such that the first mixer assembly is a dynamic mixer assembly.

In one embodiment, the mixing element provides net zero pumping force for pumping material through and out of the mixer housing tube.

In one embodiment, the system includes a shut-off pin within the mixer housing tube. The shut-off pin is selectively moveable between an open position and a closed position. The shut-off pin cooperates with the sealing surface of the outlet port to close the outlet port in the closed position. The shut-off pin is spaced from the sealing surface of the outlet port in the open position to permit fluid flow through the outlet port.

In one embodiment, the mixing element and shut-off pin are co-axial and the shut-off pin is linearly driven along a longitudinal axis about which the mixing element rotates.

In one embodiment, the mixing element includes a first set of mixing components that force the material in a first direction and a second set of mixing components that force the material in a second direction opposite the first direction to provide the net zero pumping force.

In an embodiment, a method of mixing on demand and dispensing a multi-component material from a multiple material is provided. The method includes supplying a first material from a source of a first material to a first mixer assembly by pumping the first material using a first pumping force provided by a first pumping assembly. The method includes supplying a second material from a source of a second material to the first mixer assembly by pumping the second material using a second pumping force provided by a second pumping assembly. The method includes mixing the first and second materials with the first mixer assembly to form a mixed material, the first and second materials and resulting mixed material being forced through the first mixer assembly by the first and second pumping forces. The method includes dispensing the mixed material from the first mixer assembly through an outlet port of the first mixer assembly using the first and second pumping forces.

In one embodiment, the method includes actuating a shut-off pin of the first mixer assembly between an open position and a closed position. The shut-off pin cooperates with a sealing surface of the outlet port to close the outlet port in the closed position. The shut-off pin is spaced from the sealing surface of the outlet port in the open position to permit fluid flow through the outlet port.

In one embodiment, the first and second materials travel a distance of less than 36 inches from a location where the materials begin to mix and the outlet port.

In one embodiment, the step of dispensing includes dispensing the mixed material into a mold cavity in fluid communication with the outlet port of the mixer assembly. The first and second pumping forces force the mixed material into the mold cavity.

In one embodiment, a secondary source of pumping force is not provided between the mixer assembly and the mold cavity.

In one embodiment, the first and second materials are components of a liquid silicone rubber and the mixed material is a liquid silicone rubber material.

In one embodiment, the method includes cooling the first mixer assembly during the step of mixing the first and second materials with the first mixer assembly to form a mixed material.

In one embodiment, the method includes heating the mixed material after the mixed material has been dispensed from the first mixer assembly.

In one embodiment, the step of dispensing the mixed material includes dispensing the mixed material into a cavity of a mold. The step of heating the mixed material is performed on the mixed material within the cavity of the mold promoting curing of the mixed material.

In one embodiment, the step of dispensing the mixed material includes dispensing the mixed material into a cavity of a mold. The method further includes disengaging the mixer assembly from the mold to inhibit thermal transfer between the mold and the mixer assembly.

In one embodiment, the method includes locating an electronic component within the mold. Dispensing the mixed material into the mold cavity includes encapsulating at least a portion of the electronic component with the mixed material.

In one embodiment, a cycle time is less than 5 minutes.

In one embodiment, dispensing the mixed material into the cavity of mold reaches a pressure of at least 0.5 psi.

In one embodiment, the first and second materials are components of a liquid silicone rubber and the mixed material is a liquid silicone rubber material.

In one embodiment, the first and second materials are parts of a thermoplastic material and the mixed material is a thermoplastic material.

In one embodiment, the first and second materials are components of a polyurea and the mixed material is a polyurea material.

In one embodiment, the first mixer assembly includes a mixer housing tube extending axially between an inlet end and an outlet end. The mixer housing tube defines an internal cavity. The outlet end of the mixer housing tube has an outlet port. The outlet port fluidly communicates the internal cavity with the exterior of the mixer housing tube. A mixer element is located within the internal cavity of the mixer housing tube. The mixer element and mixer housing tube forms a mixing passage fluidly connecting the first and second material inlets with the outlet port for mixing fluids flowing from the first and second material inlets to the outlet port. The method further includes rotating the mixer element within the mixer housing tube.

In one embodiment, the mixer element is balanced such that the mixing element provides a net zero pumping force as it is rotated.

In an embodiment, a mix on demand and dispensing method for multi-component material encapsulation of an electronic component is provided. The method includes supplying a first material from a source of a first material to a first mixer assembly by pumping the first material using a first pumping force provided by a first pumping assembly. The method includes supplying a second material from a source of a second material to the first mixer assembly by pumping the second material using a second pumping force provided by a second pumping assembly. The method includes mixing the first and second materials with the first mixer assembly to form a mixed material, the first and second materials and resulting mixed material being forced through the first mixer assembly by the first and second pumping forces. The method includes encapsulating at least a portion of an electronic component including dispensing the mixed material from the first mixer assembly through an outlet port of the first mixer assembly using the first and second pumping forces.

In one embodiment, dispensing includes dispensing the mixed material into a mold cavity in fluid communication with the outlet port of the mixer assembly. The electronic component being encapsulated is in communication with the mold cavity. The first and second pumping forces force the mixed material into the mold cavity and into contact with the encapsulated portion of the electronic component.

In one embodiment, a secondary source of pumping force is not provided between the mixer assembly and the mold cavity.

In one embodiment, the first and second materials are components of a liquid silicone rubber and the mixed material is a liquid silicone rubber material.

In one embodiment, the method includes cooling the first mixer assembly during the step of mixing the first and second materials with the first mixer assembly to form a mixed material.

In one embodiment, the method includes heating the mixed material after the mixed material has been dispensed from the first mixer assembly.

In one embodiment, the step of dispensing the mixed material includes dispensing the mixed material into a cavity of a mold. The step of heating the mixed material is performed on the mixed material within the cavity of the mold promoting curing of the mixed material.

In one embodiment, the step of dispensing the mixed material includes dispensing the mixed material into a cavity of a mold. The method further includes disengaging the mixer assembly from the mold to inhibit thermal transfer between the mold and the mixer assembly.

In one embodiment, a cycle time is less than 5 minutes.

In one embodiment, dispensing the mixed material into the cavity of mold reaches a pressure of at least 0.5 psi.

In one embodiment, the first and second materials are parts of a thermoplastic material and the mixed material is a thermoplastic material.

In one embodiment, the first and second materials are components of a polyurea and the mixed material is a polyurea material.

In one embodiment, the first mixer assembly includes a mixer housing tube extending axially between an inlet end and an outlet end. The mixer housing tube defines an internal cavity. The outlet end of the mixer housing tube has an outlet port. The outlet port fluidly communicates the internal cavity with the exterior of the mixer housing tube. A mixer element is located within the internal cavity of the mixer housing tube. The mixer element and mixer housing tube forms a mixing passage fluidly connecting the first and second material inlets with the outlet port for mixing fluids flowing from the first and second material inlets to the outlet port. The method further includes rotating the mixer element within the mixer housing tube.

In one embodiment, the mixer element is balanced such that the mixing element provides a net zero pumping force as it is rotated.

In an embodiment, a mixer assembly is provided. The mixer assembly includes a mixer housing tube and a mixer element. The mixer housing tube extends axially between an inlet end and an outlet end. The mixer housing tube defines an internal cavity defining a cylindrical inner surface having a first radius. The mixer element is located within the internal cavity of the mixer housing tube and has a core extending along a longitudinal axis. The core defines a cylindrical outer surface having a second radius. The cylindrical inner surface and cylindrical outer surface define a gap therebetween which provides for fluid flow through the mixer housing tube. The second radius is at least twenty five percent of the first radius. The mixer element includes a plurality mixing components extending radially outward from the cylindrical outer surface toward the cylindrical inner surface. The mixing components are axially offset from one another along the longitudinal axis.

In one embodiment, the plurality of mixing components includes a plurality of vanes that extend angularly about the longitudinal axis and outer cylindrical surface as well as axially along the outer cylindrical surface. The vanes are thus helically shaped.

In one embodiment, the plurality of vanes includes a first set of vanes that extend angularly about the longitudinal axis in a first angular direction and a second set of vanes that extend angularly about the longitudinal axis in a second angular direction that is opposite the first angular direction.

In one embodiment, the first and second set of vanes have equal numbers such that if the mixer element is rotated within the mixer housing tube the plurality of vanes provide substantially no net pumping force parallel to the longitudinal axis.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of a multi-material dispensing system;

FIG. 2 is an illustration of a static mixer assembly for use in the system of FIG. 1;

FIG. 3 is a cross-sectional illustration of a dispensing and mixing unit of the system of FIG. 1;

FIG. 4 is a further view of the dispensing and mixing unit of the system of FIG. 1 in relation to a mold;

FIG. 5 is a cross-sectional illustration of the static mixer assembly of FIG. 2;

FIG. 6 is an exploded illustration of the dispensing and mixing unit of the system of FIG. 1;

FIG. 7 is an illustration of an alternative embodiment of a dispensing and mixing unit;

FIG. 8 is a partial illustration of the dispensing and mixing unit of FIG. 7;

FIG. 9 is a cross-sectional illustration of the dispensing and mixing unit of FIG. 7;

FIG. 10 is an exploded illustration of the dispensing and mixing unit of FIG. 7;

FIG. 11 is an alternative static mixer assembly according to an embodiment of the invention;

FIG. 12 is a cross-sectional illustration of the static mixer assembly of FIG. 11;

FIG. 13 is a partial simplified illustration of an alternative multi-material dispensing system;

FIG. 14 is a cross-sectional illustration of an alternative embodiment of a static mixer assembly for use in the multi-material dispensing systems of FIGS. 1 and 13;

FIG. 15 is a cross-sectional illustration of an alternative embodiment of a dispensing and mixing unit;

FIG. 16 is a further embodiment of a static mixer assembly utilizing a spring loaded ball valve shut-off arrangement;

FIG. 17 is a simplified illustration of an electronic component in the form of a printed circuit board (PCB);

FIG. 18 is a simplified illustration of the electronic component of FIG. 17 after an encapsulation process using systems and methods of embodiments of the present invention;

FIG. 19 is a simplified illustration of a mold that includes locating features in the form of retractable pins;

FIG. 20 is a perspective illustration of a mixer element;

FIG. 21 is a cross-sectional illustration of the mixer element of FIG. 20 within a mixer housing tube;

FIG. 22 is a perspective illustration of a dynamic mixer assembly according to an embodiment of the invention;

FIG. 23 is a cross-sectional illustration of the dynamic mixer assembly of FIG. of FIG. 22 attached to appropriate actuators and a controller;

FIG. 24 is a perspective illustration of an embodiment of dispensing and mixing unit incorporating a dynamic mixer assembly;

FIG. 25 is a cross-sectional illustration of the dispensing and mixing unit of FIG. 24;

FIG. 26 is a perspective illustration of the dynamic mixer assembly of the dispensing and mixing unit of FIG. 24; and

FIG. 27 is a cross-sectional illustration of the dynamic mixer unit of the dynamic mixer assembly of FIG. 26.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

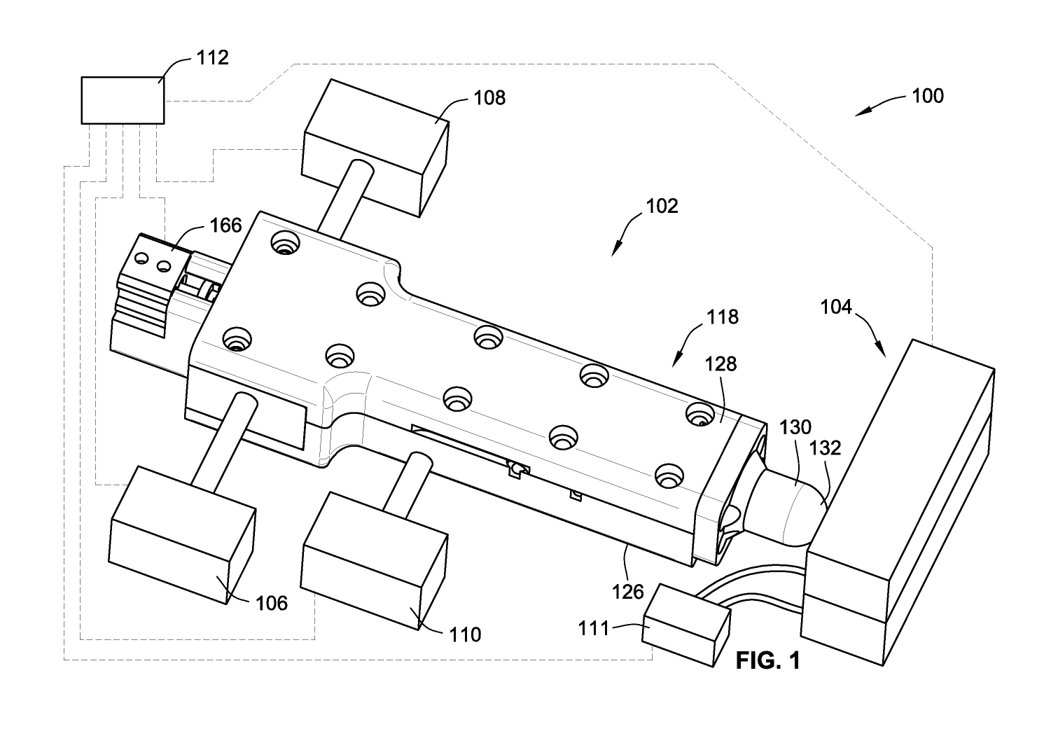

FIG. 1 illustrates a mix on demand, multi-material dispensing system according to an embodiment of the present invention. In this embodiment, the multi-material dispensing system is a molding machine 100. The molding machine 100 is configured to mold parts from a mixed material formed from a combination of a first material and a second material. While this embodiment will be described with reference to a molding machine, the features thereof can be incorporated into other systems such as systems that do not use molds, where not contradicted by the disclosure. This and other embodiments of the invention may find particularly beneficial use in encapsulating at least a portion of an electronic component.

The molding machine 100 generally includes a dispensing and mixing unit 102 that supplies material to a mold in the form of mold set 104 where the material dispensed from the dispensing and mixing unit 102 is formed into a predetermined shape defined by a mold cavity of the mold set 104. While referred to herein as a mold set, the mold set may also be referred to simply as a “mold” or as a “tool.”

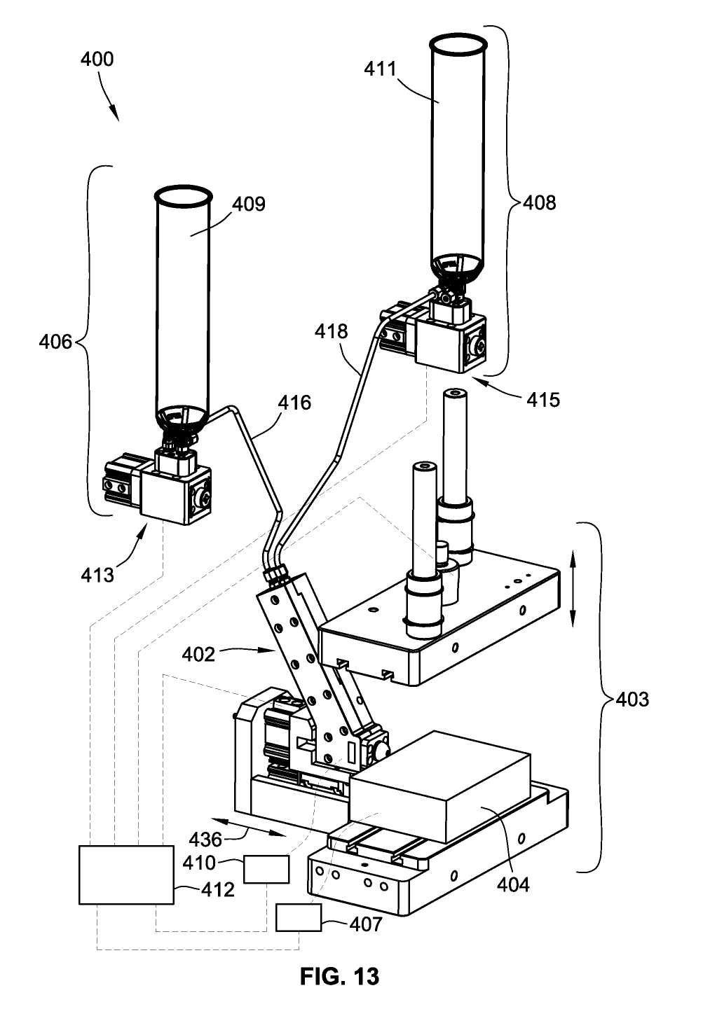

The molding machine 100 further includes first and second sources of material 106, 108, which are described in more detail with regard to a further embodiment of FIG. 13 below. The first and second sources of material 106, 108 are for supplying a first material and a second material to the dispensing and mixing unit 102. Various different materials can be supplied from the different sources of material. For example, the sources of material may provide hardeners (or other curing type agents) coloring agents, fillers, and resins. Thus, it should be noted that systems according to the invention can utilize more than two sources of material such that various combinations of materials can be made. Utilizing multi-part materials, allows easy material handling prior to mixing and dispensing. Further, when using thermoplastic materials, material degradation associated with processing the thermoplastic materials at elevated temperatures is eliminated. Additionally, the nature of mixing the multicomponent materials as they are needed, as described herein, ensures that the curing of the material does not occur prematurely. Handling the unmixed materials is much more production friendly. In the unmixed state, the materials are not as sensitive to temperature changes and storage conditions are much less stringent than when dealing with the mixed materials. Once the multicomponent materials are mixed together, the materials can begin the curing process and material handling becomes both time and temperature sensitive.

The molding machine 100 can optionally include a first heat transfer unit 110 that can either supply heating or cooling liquid to the dispensing and mixing unit 102 depending on the thermal characteristics of the mixed material dispensed from the dispensing and mixing unit 102. For example, once mixed, some materials need to remain above or below a predetermined temperature to prevent curing. The first heat transfer unit 110 can thus be used to maintain the mixed materials at a desired temperature to prevent curing within the dispensing and mixing unit 102. For example, temperature sensitive materials that cure within a short processing time when exposed to elevated temperatures can be maintained below those curing temperature to prolong the time the material remains in the uncured state. Other heat transfer units are also contemplated. For example, Peltier devices or phase change material heat exchangers could be incorporated.

The molding machine 100 can optionally include a second heat transfer unit 111 that can either supply heating or cooling liquid to the mold set 104 depending on the thermal characteristics of the mixed material. Typically, the second heat transfer unit 111 is used to improve curing of the material dispensed from the dispensing and mixing unit 102 into mold set 104. The use of the second heat transfer unit 111 may improve cure quality of the molded material. Alternatively or additionally, the use of the second heat transfer unit 111 can increase the cure rate so as to accelerate cycle times so that the throughput of molded parts of a given mold set 104 can be increased.

Finally, the molding machine 100 includes a controller 112 operably coupled to various components of the molding machine 100 for controlling the operation of the various components of the molding machine 100.

For instance, the controller can control the dispensing supply of material to the dispensing and mixing unit 102 from the first and second sources of material 106, 108, the dispensing of material from the dispensing and mixing unit 102, mating of the dispensing and mixing unit 102 with the mold set 104 by controlling movement of the dispensing and mixing unit 102 and mold set 104 relative to one another, opening and closing of the mold set 104, supplying of heating or cooling liquid from the first and/or second heat transfer units 110, 111, controlling the temperature of the heating or cooling liquid, etc. The controller 112 may be a single unit or a plurality of controllers operably controlling an individual component or components.

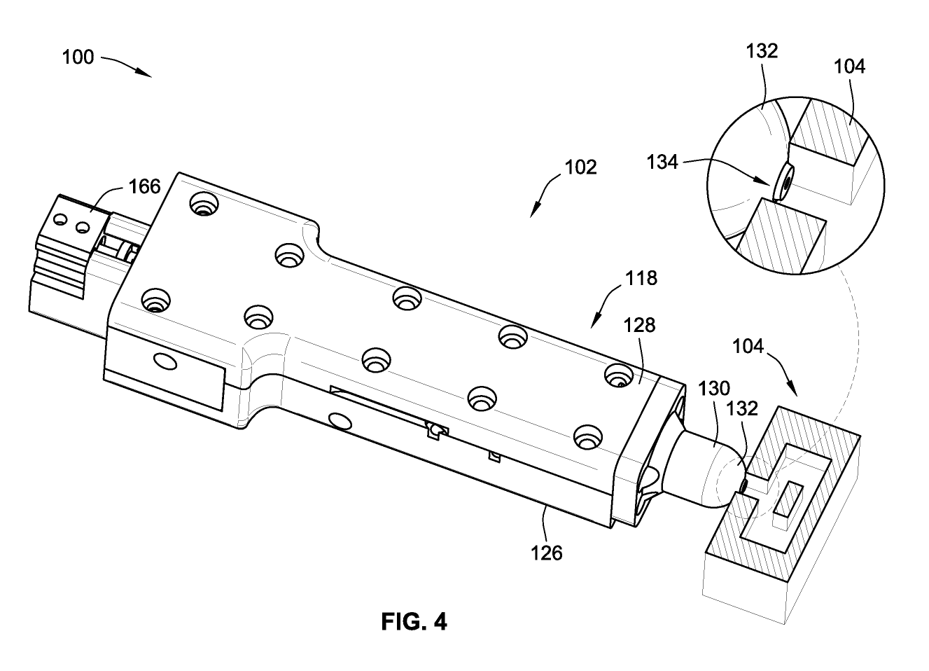

In operation, the first and second sources of material 106, 108 are under pressure to positively pressurize the first and second fluids such that they are supplied to the dispensing and mixing unit 102. Further, the dispensing and mixing unit 102 can be selectively engaged and disengaged from the mold set 104. For instance, the dispensing and mixing unit 102 may be mounted on an actuator, such as a linear actuator, for transitioning the dispensing and mixing unit 102 into and out of engagement with the mold set 104. More particularly, the dispensing and mixing unit 102 includes a nozzle 130 that mates with a corresponding receiver 134 (see FIG. 4) of the mold set 104. This linear actuator is not illustrated but could be controlled by controller 112.

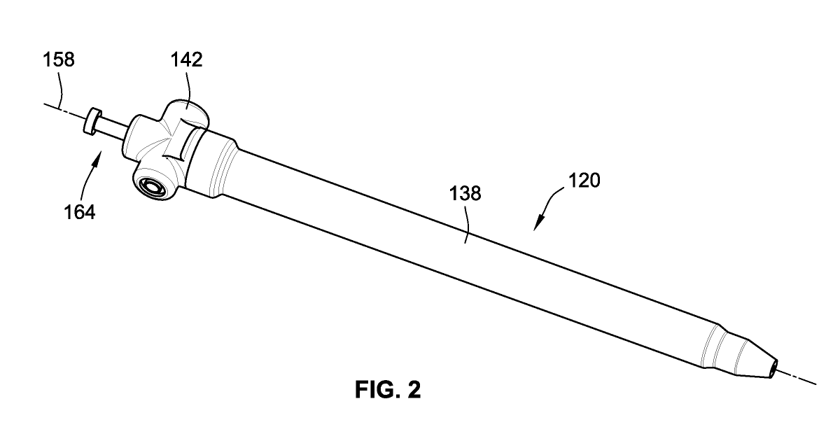

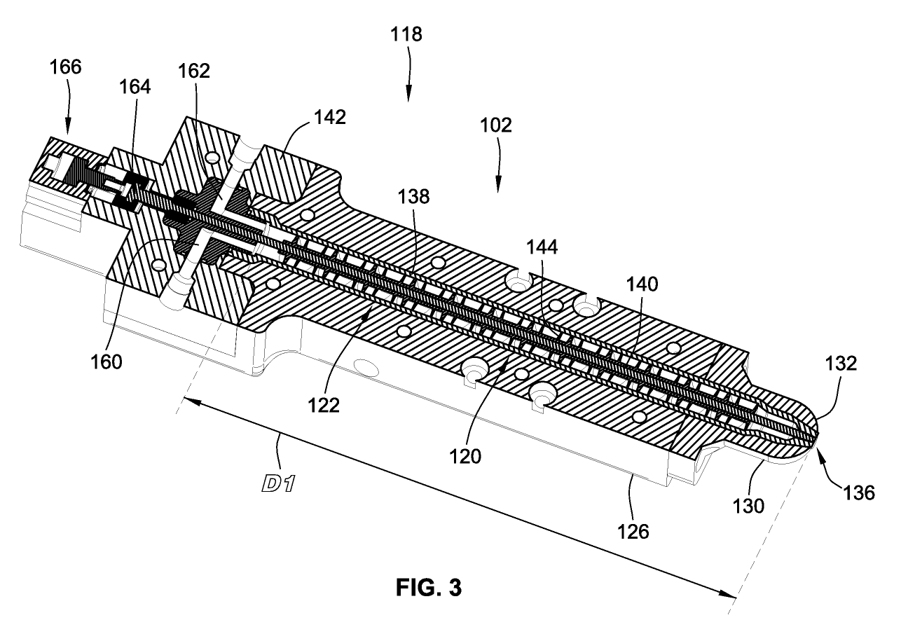

The dispensing and mixing unit 102 includes a static mixer holding arrangement 118 for holding a static mixer assembly 120 (see FIG. 2) in a static mixer holding cavity 122 (see FIG. 3). More particularly, the static mixer assembly 120 is mounted in the static mixer holding cavity 122 of the static mixer holding arrangement 118. The static mixer holding arrangement 118 and the static mixer assembly 120 are generally mating components such that the static mixer holding arrangement 118 provides pressure reinforcement of the static mixer assembly 120 such that high pressures can be used to force material through the static mixer assembly 120 without bursting the static mixer assembly 120. This is particularly useful to allow the system to process both low viscosity and high viscosity materials. In some embodiments, the static mixer holding arrangement can support the static mixer assembly 120 such that working pressures between 0 to 10,000 psi can be accommodated.

With reference to FIGS. 3 and 4, the static mixer holding arrangement 118 is a holding body that includes internal flow passages for a heat transfer fluid supplied by the heat transfer unit 110 to pass through the static mixer holding arrangement. This configuration allows for desired heating or cooling of the static mixer assembly 120 and the materials that are being mixed therein and dispensed therefrom. This can assist in preventing or promoting curing depending on the particular mixed material.

With primary reference to FIG. 3, the static mixer holding arrangement 118 includes first and second holding body portions 126, 128 that are operably connected to one another and a nozzle 130 operably connected to the first and second holding body portions 126, 128. The first and second holding body portions 126, 128 and the nozzle are removably connected to one another such that the static mixer holding cavity 122 defined thereby can be accessed for removal of the static mixer assembly 120 housed therein. These components are typically connected using bolts or screws.

The static mixer holding cavity 122 is generally shaped and sized to closely conform to the shape and size of the static mixer assembly 120 so as to provide structural support to the static mixer assembly 120. The structural support helps support the static mixer 120 from the pressure of the first and second source of materials 106, 108 for supplying the first and second materials to dispensing and mixing unit 102. Further, a close mating relationship between the static mixer assembly 120 and the static mixer holding arrangement 118 improves heat transfer between the static mixer holding arrangement 118 and the static mixer assembly 120 when such heat transfer is desired.

As illustrated in FIG. 4, the nozzle 130 has an outer surface 132 configured to mate with a corresponding mold port 134 of the mold set 104. In the illustrated embodiment, the outer surface 132 of the nozzle 130 is generally a hemisphere and the mold port 134 is the negative of the hemisphere for positive mating engagement and to prevent leakage of the mixed material that is dispensed from the dispensing and mixing unit 102. The nozzle 130 further includes an outlet port 136 through which the mixed material is dispensed from the dispensing and mixing unit 102. The material that is dispensed is injected into the mold set 104 from the static mixer assembly 120.

Turning now to FIGS. 2, 3 and 5, a first embodiment of the static mixer assembly 120 is illustrated. The static mixer assembly 120 generally includes the mixer housing tube 138, a shut-off pin 140, a material manifold 142 and a mixing element in the form of a static mixer 144.

The mixer housing tube 138 extends axially between an inlet end and an outlet end. The mixer housing tube 138 defines an internal cavity 150 generally extending between the inlet and outlet ends 146, 148. The outlet end 148 of the mixer housing tube 138 includes an outlet port 152. The outlet port 152 defines a sealing surface 154. The sealing surface 154 is a radially inner surface. The sealing surface 154 selectively cooperates with an outer surface of the distal end 156 of the shut-off pin 140 to selectively allow or prevent fluid flow through the outlet port 152. The outlet port 152, when not closed by shut-off pin 140, allows fluid to exit the internal cavity 150 and external of the static mixer assembly 120. While illustrated as a single piece, the mixer housing tube 138 could be formed from multiple components such that the internal cavity 150 is formed in part by more than one component that forms the mixer housing tube.

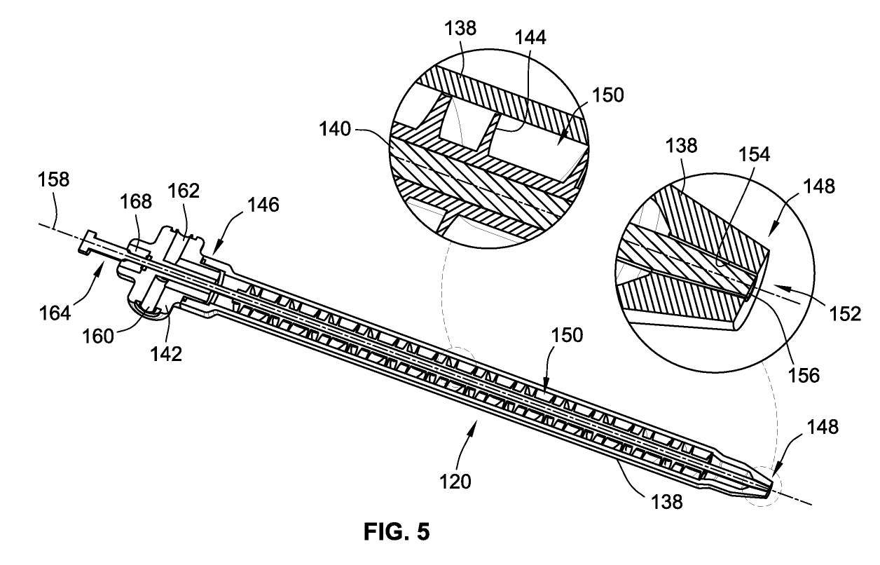

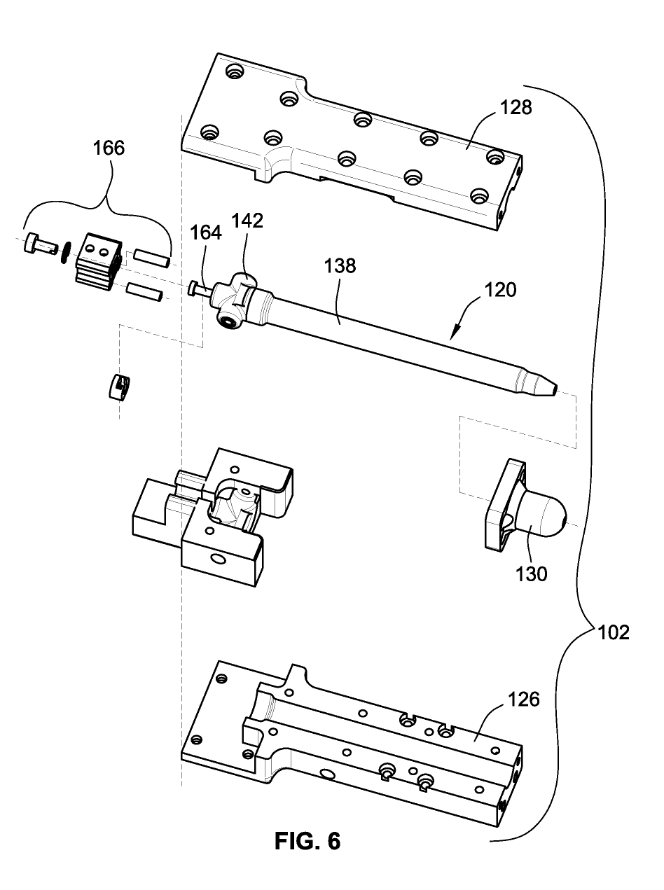

The shut-off pin 140 is located, at least in part, within the mixer housing tube 138 and particularly within the internal cavity 150 thereof. The shut-off pin 140 is selectively axially movable along a longitudinal axis 158 between an open position and a closed position. The shut-off pin is illustrated in a closed position in FIG. 5 as the shut-off pin has a distal end 156 in sealing contact with sealing surface 154 of the outlet port 152. In this position, mixed material is prevented from exiting through outlet port 152. In the open position, the shut-off pin is retracted such that the distal end 156 is spaced apart from sealing surface 154 forming a gap therebetween such that mixed material can exit the internal cavity 150 of the mixer housing tube through outlet port 152.

The material manifold 142 is located proximate the inlet end 146 of the mixer housing tube 138. While illustrated as separate components, in other embodiments, the mixer housing tube 138 and material manifold 142 could be provided by a single component. In the illustrated embodiment, the inlet end 146 of the mixer housing tube 138 is sealingly coupled to the material manifold 142 such as by way of an O-ring or other gasket.

In the illustrated embodiment, the material manifold 142 defines first and second material inlets 160, 162. The first and second material inlets 160, 162 are operably coupled to the first and second source of materials 106, 108 in operation. The first and second material inlets 160, 162 are in fluid communication with the internal cavity 150 of the mixer housing tube 138. The internal cavity 150 fluidly communicates the first and second material inlets 160, 162 ultimately with the outlet port 152. While two inlets 160, 162 are illustrated, other embodiments could incorporate more than two inlets such that more than two materials can be mixed.

Typically, the first and second sources of material 106, 108 are coupled to the inlets 160, 162 by hoses (see e.g. FIG. 13) that have couplings that sealingly mate with the material manifold 142. As the supplied first and second materials are under pressure, a mechanical connection preventing disconnection is desired. For instance, the couplings can threadedly engage the material manifold 142 or threadedly engage static mixer holding arrangement 118, such as first holding body portion 126. An O-ring, or other gasket, can be provided between the material manifold 142 and the hoses/couplings to prevent fluid leakage.

The static mixer 144 is located within the internal cavity 150 of the mixer housing tube 138. The static mixer 144 is located between the outlet port 152 and the material manifold 142 and particularly the first and second inlets 160, 162. The static mixer 144 includes a plurality of components for causing mixing of the first and second materials that enter through the first and second material inlets 160, 162. For example, the static mixer 144 could be a plate style static mixer or include a plurality of vanes for causing intermixing of the two separate materials to form the mixed material that is ultimately dispensed. The static mixer 144 will form a mixing passage that will form, at least in part, a mixing passage that operably connects the first and second material inlets 160, 162 with the outlet port 152.

In the illustrated embodiment, the shut-off pin 140 extends axially along the longitudinal axis 158. The shut-off pin 140 is housed within a central cavity of a core of the static mixer and extends through and moves relative to the static mixer 144 in the illustrated embodiment. However, in alternative embodiments, the static mixer and shut-off pin could be formed as a single unit such that oscillation of the shut-off pin between open and closed positions also oscillates the static mixer.

The shut-off pin 140 extends through the material manifold 142. The shut-off pin 140 includes a connection element in the form of connection head 164 that is external of the material manifold 142 that is operably designed to be engaged by actuator 166 (see FIGS. 1 and 3). The actuator 166 will engage the connection head 164 such that the actuator 166 can impart linear motion to the shut-off pin 140 for axial motion along longitudinal axis 158. A seal 168 will slidingly support the shut-off pin 140 and prevent fluid bypass out of the manifold back along the shaft of the shut-off pin 140.

The inclusion of the drivable shut-off pin 140 allows for selectively dispense the mixed material out of the dispensing and mixing unit 102. This allows for changing of the mold, using multiple molds, or removing parts from the mold. The use of the shut-off pin 140 prevents undesirable leakage out of the system particularly when the first and second sources of material 106, 108 maintain the first and second materials under a positive pressure forcing the materials towards the outlet port 152. The shut-off pin 140 can also be used to regulate more uniform pressure control of the dispensed mixed material.

In some instances, the material that is mixed using the static mixer assembly from the first and second materials will cure at room temperature. Unfortunately, if the material is allowed to cure in the static mixer, the system will not be able to further dispense mixed product.

As such, embodiments of the present invention have the static mixer assembly 120 configured as a disposable component. In some embodiments the mixer housing tube 138, shut-off pin 140, and static mixer 144 can be replaced as an entire unit. In such an embodiment, the material manifold 142 may be reusable. This is particularly true if the pressure of the first and second materials is such that there is no contamination of one material in the inlet of the manifold for the other material.

The mixer housing tube 138 may be connected to the material manifold 142 in numerous ways. In some embodiments, the inlet end 146 of the mixer housing tube 138 is press-fit onto a corresponding structure of the material manifold 142. A gasket may be provided between the two components to prevent undesirable leakage of the material being mixed. This may be in the form of a bell connection.

Alternative embodiments could use a bayonet style push and twist or simply twist attachment of the mixer housing tube 138 to the material manifold 142. Further embodiments may utilize a threaded engagement between the two components. Alternative means for securing the mixer housing tube 138 to the material manifold 142 could be implemented. It is contemplated that screws or bolts could be used as well as additional alternative mechanical fasteners.

While some embodiments reuse the material manifold 142, other embodiments may make the material manifold 142 a unitary part of the disposable component.

With additional reference to FIG. 1, after initialing dispensing a first mixed material and replacement of the static mixer assembly 120 is desired, the user can disconnect the first and second sources of material 106, 108 from the dispensing and mixing unit 102. Thereafter, the static mixer holding arrangement 118 may be disassembled to provide access to the static mixer holding cavity 122. More particularly, the nozzle 130 and one of the first or second holding body portions 126, 128 can be removed to provide access to the static mixer assembly 120. The static mixer assembly can then be removed as a complete unit from the static mixer holding arrangement 118. Again, this complete unit could include the mixer housing tube 138, shut-off pin 140, material manifold 142, and static mixer 144. This entire unit could then be disposed of and a second new component substantially identical to that which is being disposed of could be replaced. Alternatively, as noted above, the material manifold 142 could be reused and the unit that is replaced is the shut-off pin 140, mixer housing tube 138, and the static mixer 144.

With reference to FIG. 3, the actuator 166 is configured such that removal of the static mixer assembly 120 from the static mixer holding cavity 122 simultaneously disconnects the connection head 162 of the shut-off pin 140 from the actuator 166. In this embodiment, the actuator 166 includes a slot sized to receive the connection head 164 in a sliding manner during removal and insertion of a static mixer assembly 120.

To further facilitate easy swapping of one static mixer for a replacement static mixer, the first and second material inlets 160, 162 may be configured to provide or include couplings for operably releasably connecting the material manifold 142 to the first and second source of materials 106, 108. For instance, the inlets 160, 162 could have a sliding engagement with a hose or pipe that would operably be connected to the first and second source of materials 106, 108. Alternatively, the inlets 160, 162 could provide bayonet style or threaded style connectors for simple disconnection of the material manifold 142 from the first and second source of materials 106, 108. The mechanical connection between the sources of material and the dispensing and mixing unit 102 such that the hoses, pipes or tubes cooperating with inlets 160, 162 is not ejected due to pressurizing the material can be provided by the static mixer holding arrangement 118 or the material manifold 142.

As noted above, the static mixer 144 is located within the internal cavity 150. The internal cavity 150 may be viewed as having a mixing region that includes the static mixer 144 and a dispensing region downstream of and fluidly connected with the mixing region. The dispensing region includes the outlet port 152. The shut-off pin 140, of this embodiment, extends through both the mixing region and the dispensing region.

Again, this embodiment that utilizes the static mixer holding arrangement 118 which is configured to hold the static mixer assembly 120 is used, generally, in molding arrangements where the mixed material is dispensed into a mold set 104 (See FIG. 1). Again, the static mixer assembly 120 can be made as a disposable unit such that if the mixed material within the static mixer assembly 120 is allowed to, undesirably, cure, only the static mixer assembly 120 needs to be replaced and this can be done rather quickly and simply in a cost efficient manner. The simple design of embodiments of the dispensing and mixing units described herein allows for rapid change of the static mixer assembly and shut-off pin if the materials undesirably cure prior to being dispensed from the dispensing and mixing unit. Further the design is such that if material cures within the system, it is limited to the cavity of the mold set and within the components of the static mixer assembly. Again, this ensures that high cost parts, e.g. pumps, are not exposed to the mixed material, which if cured when in contact with the part, would require the part to be replaced.

With reference to FIG. 3, it is a feature of an embodiment of the invention that the mixing of the materials and dispensing of the mixed materials occurs quickly to avoid undesirable premature curing of the mixed materials. In one embodiment, the travel distance D1 between the location where the two materials first come into contact, i.e. proximate the outlet ends of inlets 160, 162 of manifold 142 to the outlet port 136 of the mixer housing tube 138 is no greater than 36 inches, and more preferable no greater than 15 inches, and even more preferably no greater than 10 inch. The distance D1 can be as short as 1 inch. Typically, distance D1 will be between 3 and 20 inches. Further, in some methods of utilizing the system, the amount of time it takes for the material to exit the inlets 160, 162 and to be dispensed from outlet port 136 is less than 10 minutes, more preferably less than 5 minutes. The close proximity of the static mixer and particularly the resulting short distance D1 allows the longest possible open time needed for each material and provides particular benefits when processing materials with short working times that would otherwise normally begin setting up (e.g. curing) prior to being dispensed, either into a mold or other location, such as when potting.

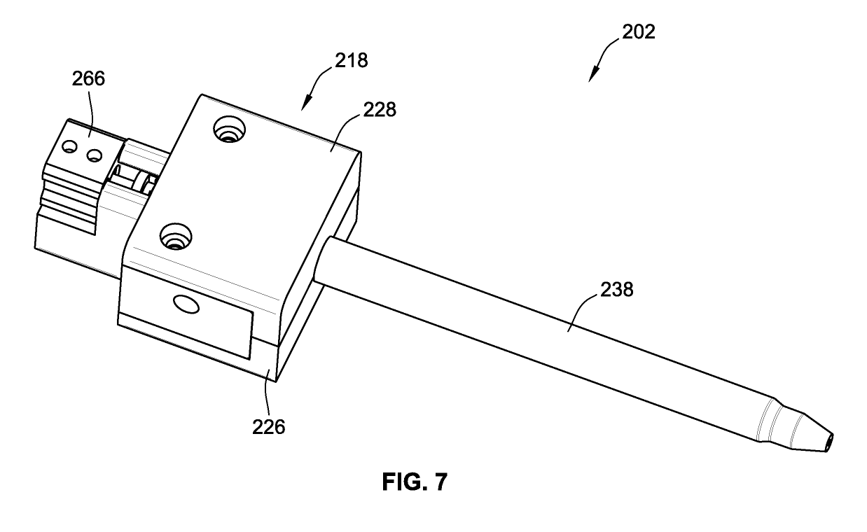

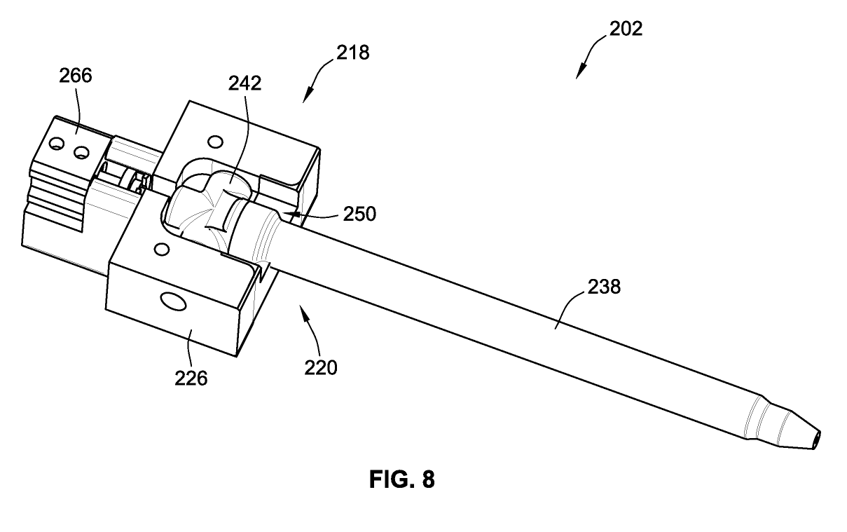

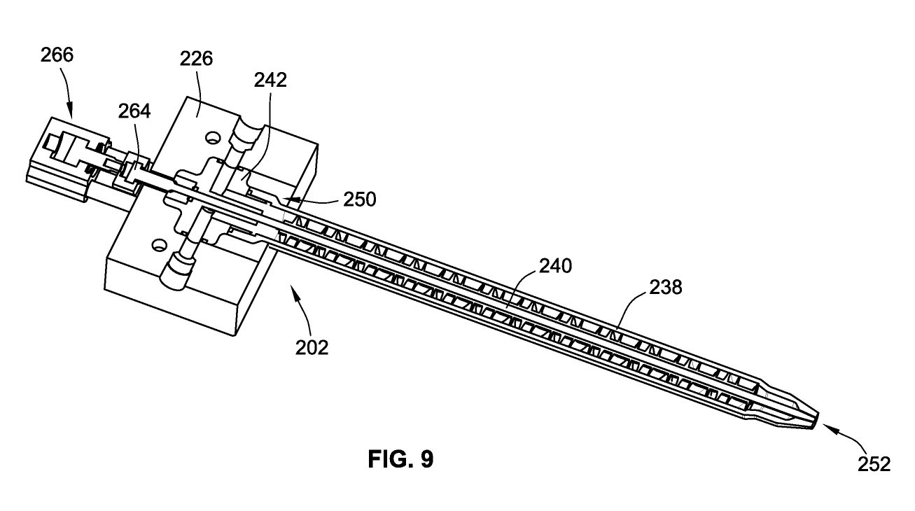

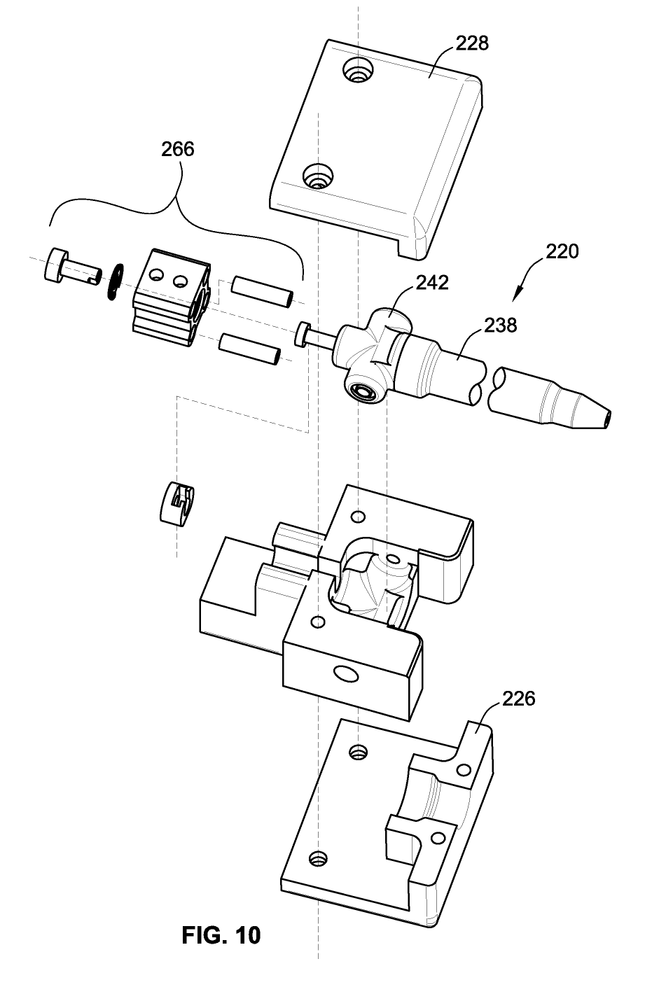

FIGS. 7 and 8 illustrate a further embodiment according to the invention. This embodiment illustrates an alternative dispensing and mixing unit 202 for a multi-material dispensing system. This embodiment uses a modified static mixer holding arrangement 218 that does not require surrounding the super majority of the static mixer assembly 220. It is noted that the static mixer assembly 220 is substantially identical to static mixer assembly 120 described above. This dispensing and mixing unit 202 finds particular use when the dispensing and mixing unit is used simply for dispensing the mixed material. This system, while possible, would typically not be used with a mold set such as in the prior molding machine 100.

This embodiment of the static mixer holding arrangement 218 does not include the heat extraction or heat addition capabilities of the prior static mixer holding arrangement 118. Thus, typically, this unit would not be connected to a heat transfer unit such as heat transfer unit 110 of the prior embodiment.

The static mixer holding arrangement 218 of this embodiment generally only includes first and second holding body portions 226, 228. The internal cavity 250 defined by the first and second holding body portions 226, 228 is sized to receive the material manifold 242 and the inlet end of the mixer housing tube 238. Again, an actuator 266 is provided for coupling to the connection head 264 of the shut-off pin 240. In this embodiment, the mixed material is directly dispensed from the outlet port 252 defined by the mixer housing tube 238.

It is noted that the connection head 264 uses the same connection style to actuator 266 as in the prior embodiment. However, both of these embodiments could utilize different connections between the actuator and the shut-off pin. For instance, the connection could be provided by a threaded connection or other quick disconnect fittings such as a bayonet style mount.

While not illustrated, this dispensing and mixing unit 202 would be connected to multiple sources of material as well as a controller as discussed previously. Further, this dispensing and mixing unit 202 could be connected directly to a robot or other mechanism for controlling the path along which the mixed material is dispensed. For instance, the dispensing and mixing unit 202 could be connected to a robotic arm or a gantry (e.g. a 3-D table) that provides motion in multiple axes such as linear axis along an X, Y, and Z axis for 3-dimensional motion and dispensing.

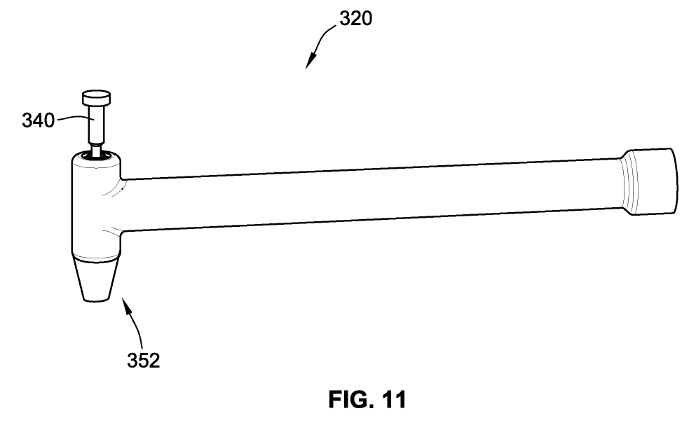

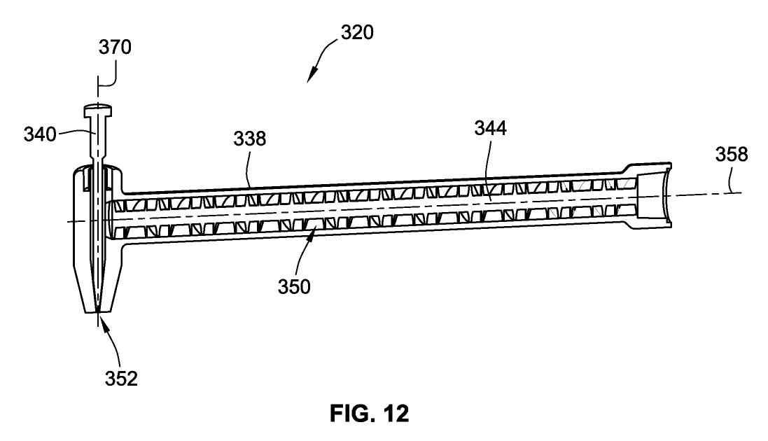

FIGS. 11 and 12 illustrate a further embodiment of a static mixer assembly 320 according to an embodiment of the present invention. In this embodiment, the shut-off pin 340 is not coaxial with the mixing element in the form of static mixer 344. In this embodiment, the shut-off pin 340 does not extend through the mixing region of the internal cavity 350 of the mixer housing tube 338. Instead, the shut-off pin 340 is located downstream from the static mixer 344 and is located only in the dispensing region of the internal cavity 350. In this embodiment the shut-off pin 340 is actuated along a drive axis 370 that is non-parallel to the longitudinal axis 358 generally defined by the static mixer 344. Further, the shut-off pin 340 is entirely downstream of the static mixer 344. While the drive axis 370 and the longitudinal axis 358 are illustrated as being substantially perpendicular to one another, other embodiments could have the two axes at different angles relative to one another, such as, for example, 45° or 60°.

Again, however, the shut-off pin 340 is transitionable between a closed position and an open position to selectively allow for dispensing of mixed material from the outlet port 352. According to this embodiment, the outlet port 352 is not coaxial with the longitudinal axis 358 of the static mixer as in the prior embodiments. This alternative arrangement of the static mixer assembly 320 could be implemented in either a molding machine type system of the first embodiment or in a simple dispensing system like in the second embodiment. Notably, there would be some redesign necessary for holding the static mixer assembly 320 and allowing for actuation of the shut-off in 340.

The inlet end of the mixer housing tube 338 is configured similar to the inlet end of the prior embodiments and would be able to releasably connect to a material manifold in a similar manner as described previously. In this embodiment, the distal end of the shut-off pin 340 extends entirely through the outlet port 352 and is exteriorly exposed of the mixer housing tube 138. However, it need not be configured in this way for all embodiments.

FIG. 13 illustrates a multi-material dispensing system according to an embodiment of the present invention. In this embodiment, the multi-material dispensing system is a molding machine 400. This multi-material dispensing system is similar to system 100 described above but illustrated in slightly more detail.

The molding machine 400 generally includes a dispensing and mixing unit 402 that supplies material to a mold set 404 that can be clamped between a holding arrangement 403. Embodiments of the holding arrangement 403 can incorporate clamping systems that utilize hydraulic actuation devices, pneumatic actuation devices, electronic motor driven actuation devices, gear driven, and manual clamping mechanisms. Further, systems could incorporate various linkages such as four bar mechanisms for driving the clamping systems.

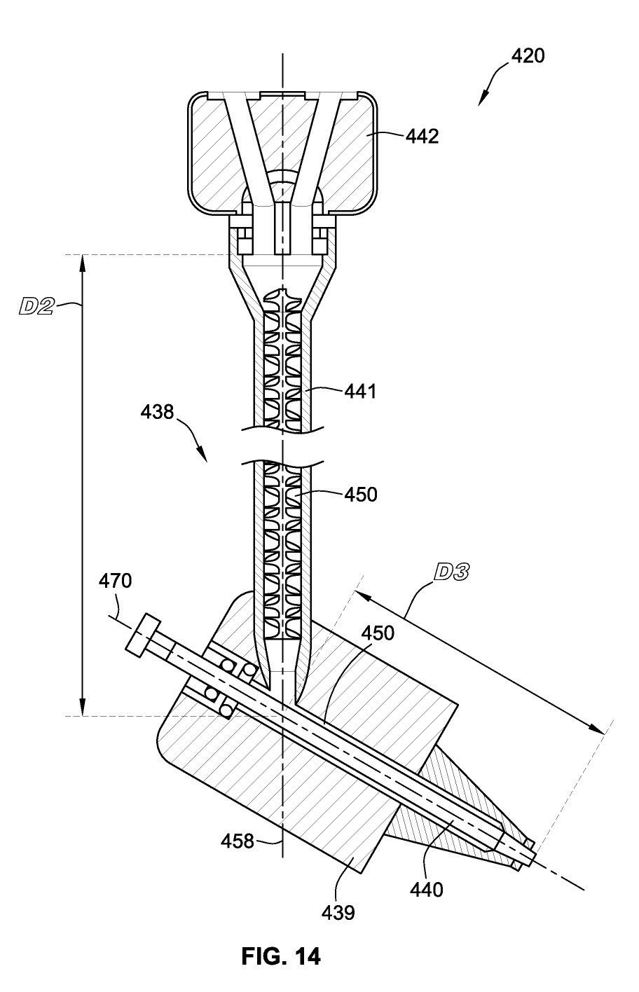

Material dispensed from the dispensing and mixing unit 402 will be dispensed into the mold set 404 and formed into a predetermined shape. The dispensing and mixing unit 402 will include a static mixer assembly 420 (illustrated in FIG. 14). While not necessary in all embodiments of the molding machine 400, molding machine 400 incorporates heat transfer units 407, 410 similar to heat transfer units 110, 111 discussed with prior embodiments so as to regulate the temperature of the dispensing and mixing unit 402 and the mold set 404.

The molding machine 400 further includes first and second sources of material 406, 408. The first and second sources of material 406, 408 are for supplying a first material and a second material to the dispensing and mixing unit 402. Various different materials can be supplied from the different sources of material. For instance, the sources of material may provide hardeners (or other curing type agents) coloring agents, fillers, and resins. While only two are shown, systems according to embodiments of the invention can utilize more than two sources of material such that various combinations of materials can be made.

The first and second sources of material 406, 408 include first and second material holding reservoirs 409, 411 for holding, separately, the first and second materials. The first and second sources of material 406, 408 also include pumping assemblies 413, 415 for selectively pumping the first and second materials to and through the dispensing and mixing unit 402. In this embodiment, the first and second materials are gravity fed from the material holding reservoirs 409, 411 into the pumping assemblies 413, 415. However, delivery mechanisms such as pressure, pistons or screws, for example, could be used to force the material into the pumping assemblies 413, 415, particularly if the material is highly viscous. Feed lines 416, 418 between the pumping assemblies 413, 415 and dispensing and mixing unit 402 may be stainless steel or high pressure reinforced hoses to withstand high operating pressures.

In a particular embodiment, the pumping assemblies 413, 415 are in the form of plunger arrangements that utilize a plunger for pushing the first and second materials. Even more preferably, the plungers are configured such that each stroke of the plunger pushes the correct amount of each material to form a desired product. Other embodiments can use pumps, such as gear pumps, progressive pumps, lobe pumps or other pumping devices for pumping the material to and through the dispensing and mixing unit 402.

Further, the illustrated molding machine 400 is also a mix on demand system where the force generated by the pumping assemblies 413, 415 for pumping the individual materials in their unmixed state to the dispensing and mixing unit 402 and then through the dispensing and mixing unit 402 is also the force used to push material into the mold set to form the end product. As such, it is a feature of a mix on demand system, such as the present embodiment, that the force used to mix the multiple materials (e.g. first and second materials stored in reservoirs 409, 411) by pushing the materials through the dispensing and mixing unit 402 and particularly the static mixer 420 thereof is also used to dispense the material into its final location for formation of a part. In this embodiment, as the system is a molding machine, this force is used to pump the mixed material into mold sets. Other systems according to teachings of the invention, such as potting systems that use the mix on demand system will use the same force to push the material through the dispensing and mixing unit and then to the location where it will be ultimately cured. Thus, in a mix on demand system, a secondary source of pumping force is not provided between mixing of the multiple materials and the ultimate cure location (e.g. where the mixed material is potted or molded).

Two particular implementations of embodiments of the present invention incorporate the mix on demand arrangement into transfer molding systems as well as liquid silicone rubber molding.

A significant benefit arises from this arrangement, unlike prior embodiments where the multipart materials are premixed and then supplied to a supply source and dispensed directly into the mold set to form a desired part, if the instant machine gets turned off, there is very limited mixed material that can undesirably cure. This is particularly true if the mixed material is a thermosetting material that must be maintained above or below a predetermined temperature to avoid curing. As such, if the machine gets turned off along with any heat transfer unit (as discussed above with reference to FIG. 1) used to prevent curing of the mixed material within the dispensing and mixing unit 402, only the material within the dispensing and mixing unit 402 will undesirably cure. All of the material remaining within the reservoirs 409, 411 will remain separated and useable. While the illustrated dispensing and mixing units include shut-off pins, other embodiments can utilize this concept of using the same devices to push the materials through mixer and into the mold sets without the use of a shut-off pin. This would be particularly true if the materials are sufficiently viscous that drippage is not an issue.

The controller 412 of the system, or if separate controllers are used, the controller of the pumping assemblies 413, 415, can be programmed to control the pumping assemblies 413, 415 such that the pumping assemblies 413, 415 are operated to dispense the desired amount of material necessary to force the necessary amount of material through the system. More particularly, the necessary amount of unmixed material will be pumped toward and/or through the dispensing and mixing unit 402 such that the necessary amount of mixed material is dispensed. In this system, that necessary amount of mixed material is the amount of material necessary to fill the cavity in the mold set for forming a desired part.

The controller 412 can be programmed to control the pumping assemblies 413, 415 such that any material component percentage of the various materials could be used. The controller 412 can be programmed to dispense by volume or by weight and density variations can be programmed into the machine to ensure that proper shot control is maintained (e.g. that the appropriate volume of material is dispensed such that the molds are properly filled during each cycle).

The dispensing and mixing unit 402 is actuatable by an actuation arrangement into and out of engagement with the mold set 404, illustrated by arrow 436. One of the benefits of this action is that, often, the dispensing and mixing unit 402 will be heated or cooled in an opposite manner as the mold set 404. Thus, once the mixed material is fully dispensed into the mold set 404, the dispensing and mixing unit 402 can be disengaged from the mold set 404 to prevent heat transfer between the two components to avoid promoting premature curing of the mixed material that remains within the dispensing and mixing unit 402. For example, if in one setup, the dispensing and mixing unit 402 is cooled to inhibit curing of the mixed material, the mold set 404 will often be heated to promote or accelerate curing of the mixed material after it has been molded. Thus, the two components can be disengaged after sufficient material has been fully injected into the mold set 404 to prevent heat from the mold set 404 transferring to the dispensing and mixing unit 402 and causing premature curing of the mixed material within the dispensing and mixing unit 402 while the system is waiting for the material within the mold set 404 to cure.

FIG. 14 illustrates a further embodiment of a static mixer assembly 420 that can be used in the multi-material dispensing system 400 of FIG. 13. In this embodiment, the mixer housing tube 438 is formed from a plurality of components attached together. For instance, the portion 439 of the mixer housing tube 438 through which the shut-off pin 440 extends could be formed from one piece while the portion 441 of the mixer housing tube 438 that holds the static mixer (not shown) could be formed from a separate piece and the two pieces could be connected together. Portions 439 and 441 combine to form internal cavity 450 through which the material flows after it exits material manifold 442.

This embodiment further illustrates where the longitudinal axis 458 that will run parallel to the flow of material through the static mixer is non-perpendicular and non-parallel to the drive axis 470 along which the shut-off pin 440 is driven.

Further, the combined values of distances D2 and D3 are minimal to again avoid undesirable curing within the static mixer assembly 420. The combined values are preferably close to the values of D1 described above. However, the combined value may be slightly greater in view of the fact that the shut-off pin 440 of this embodiment is located in a completely separate portion of the internal cavity 450 of the mixer housing tube 438. The sum of distances D2 and D3 along the central axes of the corresponding portions 439, 441 may be referred to as the distance from the outlet ends of the inlets of the manifold to the outlet port of the static mixer housing tube 438.

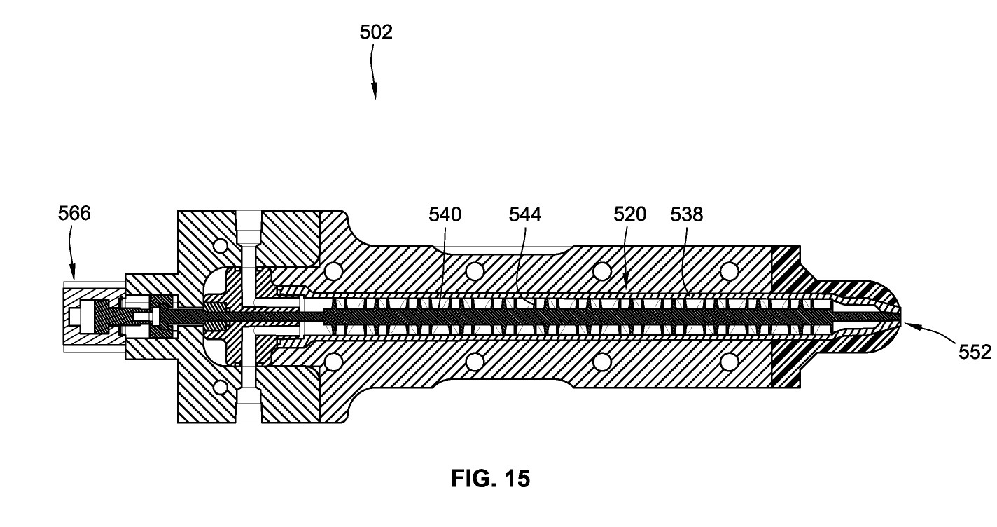

FIG. 15 illustrates a further embodiment of a dispensing and mixing unit 502. In this embodiment, the shut-off pin 540 and the mixing element in the form of a static mixer (illustrated by the vanes 544 of the static mixer) of the static mixer assembly are formed as a single one-piece component. In this embodiment, the actuator 566 will drive both the shut-off pin 540 and the vanes 544 forming the static mixer in reciprocal motion within mixer housing tube 538 when opening and closing the outlet port 552.

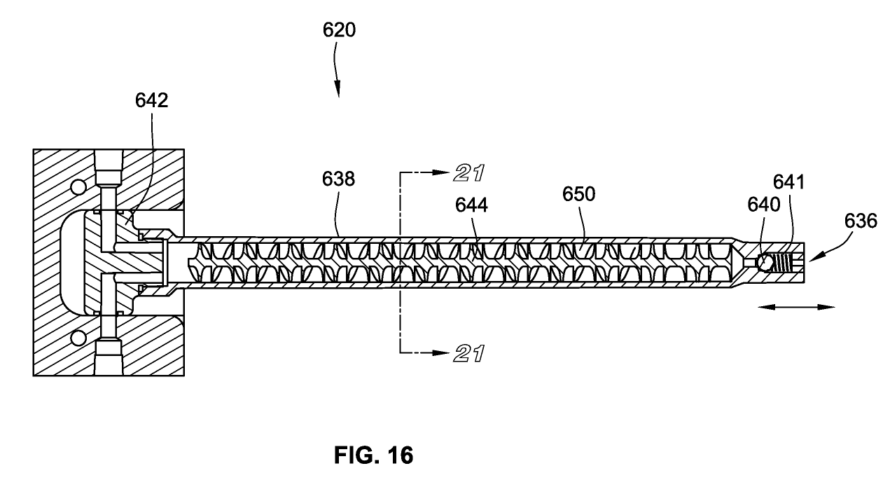

FIG. 16 illustrates a further embodiment of a static mixer assembly 620. In this embodiment, the shut-off pin is in the form of a check valve arrangement proximate outlet port 636. Unlike the elongated shut-off pins of prior embodiments, the check valve arrangement is a sealing ball 640 biased against a sealing surface of the mixer housing tube 638.

In operation, when the mixed material is pushed through the static mixer 144, the pressure thereof will actuate the sealing ball 640 away from sealing engagement with the mixer housing tube 638. When pressure is reduced, such as when no further material is need to be dispensed, the spring 641 will bias the sealing ball back into contact with the sealing surface of the mixer housing tube 638. The shut-off mechanism will reduce the likelihood of drippage from the internal cavity 650 through outlet port 636 when product is not being dispensed.

The inclusion of the shut-off pin in embodiments of the invention allows for selective dispensing of material. The user can selectively open or close the outlet ports of the various embodiments to dispense material and/or prevent dispensing when desired. This prevents undesirable leakage or drippage of material when it is not desired to dispense a product. This is particularly true where the first and second sources of material are typically provided with a constant positive pressure, albeit potentially minimal so as to prevent undesirable contamination or backflow of one of the materials into the other material source and to prevent undesirable curing in the material manifolds.

Further, by providing disposable units such as the inclusion of the mixer housing tubes, shut-off pins, and static mixers, it is possible to provide kits that include a plurality of the static mixer assemblies such that if one becomes clogged undesirably, it can be easily and cost effectively swapped with another and dispensing can continue.

The systems outlined above find particular use in multi-part electronic encapsulation where an electronic component, such as a printed circuit board (PCB), for example, is encapsulated to provide durability and protect the electronic component from potentially harsh operating environments. Multi-part electronic encapsulation shall include partially encapsulating an electronic component or entirely encapsulating an electronic component. This is particularly true due to the wide operating conditions under which the systems can be operated.

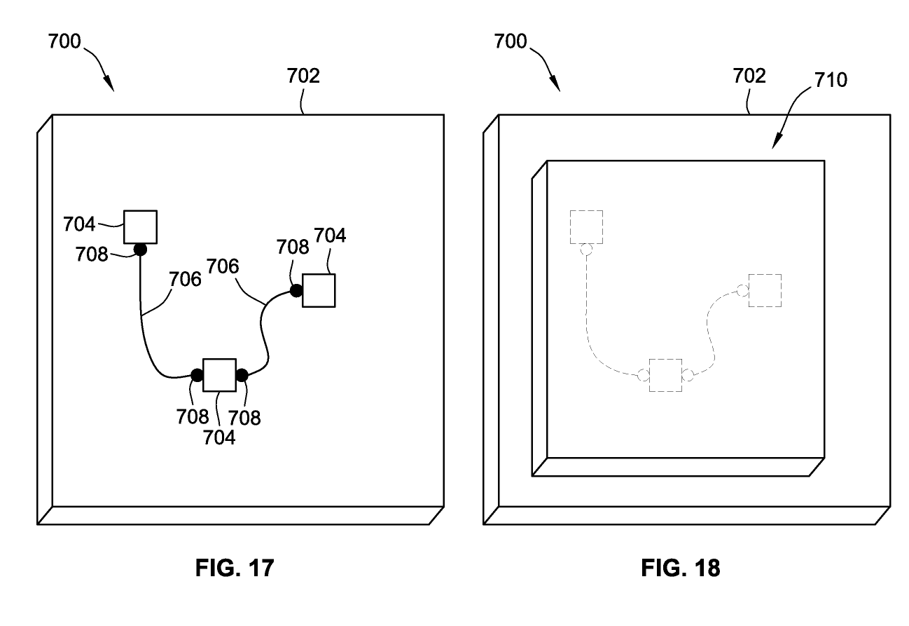

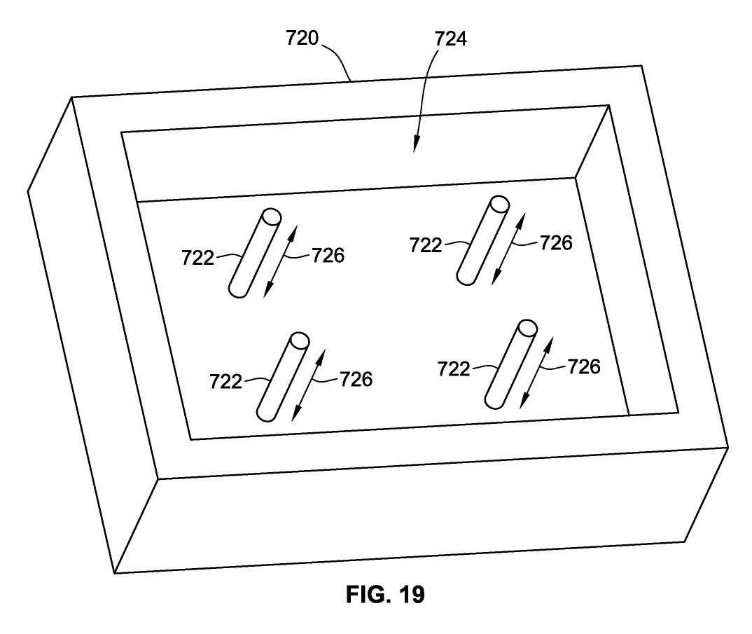

FIG. 17 is simplified schematic of an electronic component 700 prior to being encapsulated. The electronic component 700 is a highly simplified representation of a PCB that includes a substrate 702 several electrical components 704 connected by traces 706. Typically, the electronic components 704 are connected to the traces 706 by solder 708. FIG. 18 illustrates the electronic component 700 encapsulated by an encapsulant 710. While the encapsulant 710 is shown as a simple block of material, it can take on other shapes as necessary due to the shape of the electronic component. Further, while encapsulant 710 is formed on a single side of the electronic component 700, other embodiments could have the encapsulant 710 fully surround the electronic component 700. The encapsulant 710 is formed from the mixed material produced by the systems outlined above.

The systems outlined above allow an end user to use a plethora of different types of multi-part materials that were previously required to be processed on different machines. Both molding and dispensing systems according to embodiments of the invention can be used on materials that require injection pressures between 0.5 psi and 2500 psi. The pressure reinforcement of the static mixer assemblies by the static mixer holding arrangements helps facilitate the higher pressure operations. Further, the pressures through the system and even into a mold cavity, when used, can be precisely controlled by varying the pumping of the material being pumped by the sources of material and particularly the pumping assemblies (e.g. pumping assemblies 413, 415), thereof. By allowing for precise control of the pressures, particularly within a mold, appropriate injection pressures can be maintained for sensitive electronic components within the PCB assembly.

Further, the system can be used for very short cycle times such as cycles that vary from 15 seconds to less than 7 minutes and more preferably less than 5 minutes. These cycle times will vary dependent on the geometry of the parts being formed, the material being injected into the molds or being generally dispensed, and the curing temperatures.

The close proximity of the mixing process performed by the static mixer assemblies to the end forming location, such as within a mold set during a molding process, enables materials that are typically only dispensed into or onto parts to be precisely injected into the mold where efficient heat transfer provides a uniform temperature distribution and cures the material much more efficiently than placing the parts in a cure oven.

Embodiments can be used to process any multi-part thermoset material (such as for example, multi-part silicones, epoxies, urethanes, polyureas, etc.).

The following are some examples of mixed materials that can be processed and formed using some or all of the systems and methods presented herein. The following will also present some basic components of the mixed materials. However, one of ordinary skill in the art will recognize that other materials and other starting materials may be used to form the various different mixed materials that can be processed using some or all of the systems and methods presented herein. The following lists are simply illustrative in nature and by no means not all encompassing or intended on being limiting unless expressly added to the claims.

### Epoxies:

A resin containing epoxy functional groups is reacted with a hardener or crosslinker. Examples of epoxy resins are bisphenol A, bisphenol F, novolac, cycloaliphatic. Examples of hardeners are aliphatic or aromatic amines, amides, polyamidoamines, polyamides, polysulfides, imidazoles, anhydrides, boron trifluoride, dicyandiamide.

### Silicones:

A silicone resin or fluid has the backbone Si—O—Si—O—Si—O, typically methylated, with reactive functional groups reacted with a chain extender, resin, or crosslinking agent. Typical reactive systems are (1) addition cure, in which a vinyl functional silicone resin or fluid is reacted with a Si—H functional crosslinker in the presence of a platinum or other similar noble metal catalyst, (2) moisture cure in which alkoxy functional silicone resin or fluid is reacted with other alkoxy or silanol functional fluids through exposure to moisture, (3) condensation cure in which alkoxy functional silicone resin or fluid is reacted with other alkoxy or silanol functional fluids in the presence of a catalyst, typically tin or titanium based.

### Urethanes:

A resin containing alcohol functionality, typically referred to as a polyol, is reacted with an isocyanate. Examples of polyol resins are polyether, polyester, caprolactone, polycarbonate, castor oil, polybutadiene. Examples of isocyanates include 4,4′-methylene diphenyl diisocyanate, hexane 1,6-diisocyanate, toluene diisocyanate, isophorone diisocyanate.

### Polyureas:

A resin containing amine functionality is reacted with an isocyanate. Examples of amine functional resins are polyaspartics, polyethyleneoxide amines, aliphatic or aromatic polyamines, 1,6-hexanediamine. Examples of isocyanates are given above under “Urethanes”.

The following additives can be present with some or all chemistry/resin, where appropriate when using systems or methods of the instant application: surfactants, defoamers, thickeners, solvents, wetting aids, flow agents, matting agents, leveling agents, thixotropic agents, dyestuffs, pigments, colorants, fillers, initiators, catalysts, antioxidants, UV absorbers, moisture scavengers, plasticizers, reactive or nonreactive diluents, brighteners, adhesion promoters, release agents, cure inhibitors, flame retardants.

Many thermosets or multipart materials require long curing times at room temperature. Embodiments of these systems that incorporate heat transfer units for controlling the temperature of the dispensed material during curing, such as in the mold sets, reduce the cure time by appropriately elevating or lowering the temperature accordingly. Typically, the temperature will be elevated to provide a source of the needed energy levels to reach the desired enthalpy of formation of the material being utilized.

Further, the viscosities of the materials that can be processed within embodiments of the invention are much wider than those processed in traditional low pressure injection molding machines. The nature of thermoplastic materials is such that the viscosity increases with the material cooling, and this transition happens quickly such that injection pressures need to be high to process high viscosity materials. Thermoset resins often exhibit a drop in viscosity at elevated temperature prior to the initiation of the injection of high viscosity materials, such that they can be controlled to the desired pressure settings without over pressurizing the electronic components, e.g. PCB components. Materials with viscosities as high as 1,000,000 cPs can be utilized within the system and injection pressures could be limited by monitoring the fill rates of the high viscosity material such that the pressures never exceed 2,500 psi. The process and systems can be accommodate materials with low viscosities as low as 150 cPs. The use of the shut-off pin after the static mixer in various embodiments helps prevent drooling when using the high pressures or low viscosities.

With reference to FIG. 19, when the dispensing system is a molding system, the molds 720 (only one half illustrated in FIG. 19) can utilize locating features 722 (bosses, pins, retractable pins, retractable bosses, etc.) to locate the electronic component (e.g. PCB) within the mold cavity 724. The locating features 722 ensure that the electronic component stays in the correct location when the material is being injected into the cavity 724 of the mold. The locating features 722 ensure that the electronic component does not float toward a surface of the encapsulant while the mixed material is being injected into the cavity 724 of the mold 720. The locating features 722 can be designed to minimize the surface with the electronic component to minimize the amount of heat transferred to the electronic component due to heating of the molds 720 using the heat transfer units. Molding temperatures are intended to remain below the temperature at which solder on the PCB's will reflow, but could exceed those temperatures for short periods of time, as long as the energy need to reflow the solder is not met.

The locating features 722 within the molds 720, in some applications, can be retractable. The illustrated locating features 722 are selectively retractable into the body of the mold as illustrated by arrows 726. Retractable locating features 722 allow the end user to locate the electronic component while the mold cavity 724 is being filled. Prior to the material being completely cured, the retractable locating features 722 are retracted and material is injected into the empty spaces in the previously injected material left from the retractable locating features 722. The control of the retractable locating features 722 occurs after a boundary layer of material is cured along the surface of the mold cavity 724 and while the inner section of the material remains liquid enough to continue injecting material into the cavity 724 while maintaining minimal displacement of the electronic component within the mold cavity 724.

The present systems and methods allow processing of materials that have not typically been available for encapsulating of electronic components and particularly PCBs to be used. The present systems and methods remove the limitations associated with the materials such as: material hardness, chemical resistance, long processing times, and high operation costs.

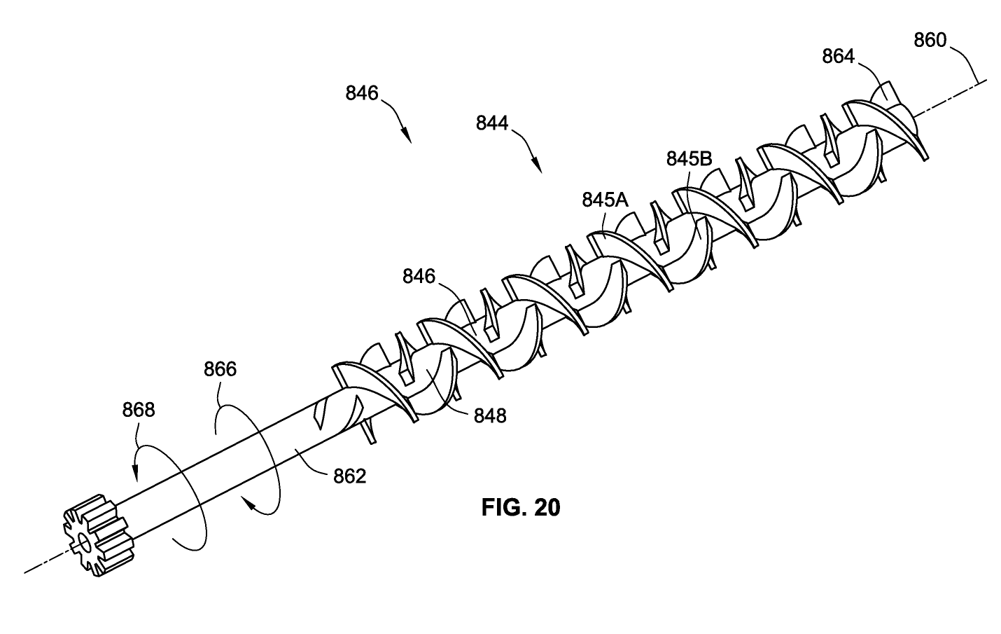

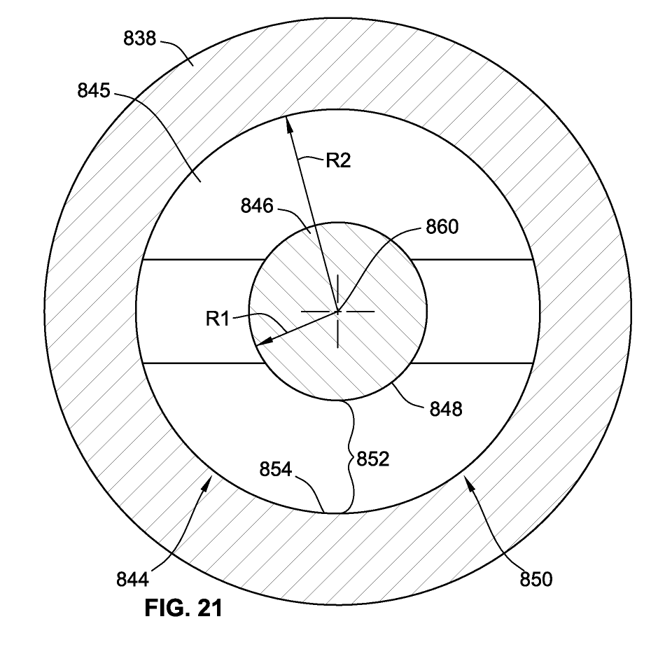

FIGS. 20 and 21 illustrate a portion of an embodiment of a mixing element 844. This mixing element 844 has preferred geometry that can be used to improve mixing whether the particular system uses static mixing or dynamic as described herein. The mixing element 844 can therefore be a static mixer or a dynamic mixer and would be housed in a mixer housing tube as illustrated and described herein.

The mixing element 844 generally includes a solid core 846 that will take up space within the internal cavity 850 of the mixer housing tube 838. By having an enlarged core 846 take up space within the internal cavity 850, the cross-sectional area available for flow of fluid through the internal cavity 850 of the mixer housing tube 838 is reduced which causes an increase in velocity profiles within the mixer assembly. The increased velocities result in better mixing of the materials flowing through the mixer assembly.

In the illustrated embodiment, the core 846 is generally circular in cross-section and defines outer surface 848. The gap 852 between the outer surface 848 of the core 846 and the inner surface 854 of the internal cavity 850 provides the fluid flow bath as the materials flow through the mixer assembly. In the illustrated embodiment, the core 846 has a radius R1 and the inner surface 854 has a radius R2 such that gap 852 is generally R2-R1. Preferably, R1 is at least 20% of R2 and more preferably at least 25% of R2.

To facilitate mixing, mixing element 844 further includes mixing components in the form of vanes 845 to redirect and mix the materials as the materials flow through the mixing assembly. The vanes 845 extend radially outward from and wrap angularly around the outer surface 848 of the core 846 and central axis 860. Further, the illustrated vanes 845 have an axial component to their geometry such that they also extend axially along central axis 860. By having the enlarged core 846, the radial dimension of the mixing components, e.g. vanes 845, is reduced which also increases the strength of the mixing components which allows the mixing element 844 to withstand higher pressures for processing more viscous materials.

With reference to FIG. 20, the vanes 845 of the mixing element 844 also vary such that they direct the flow of fluid in different directions about the central axis 860. For instance, if fluid is flowing from first end 862 towards second end 864, vane 845A will direct fluid angularly clockwise, illustrated by arrow 866, about central axis 860 while vane 845B will direct fluid angularly counter-clockwise, illustrated by arrow 868, about central axis 860. The changing in direction helps promote mixing of the materials.

While one embodiment of a mixing component is illustrated in FIG. 20, other geometry can be incorporated. For instance, mixing components in the form of radially extending pins or rods could be incorporated that will cause the materials to change directions as it flows axially from the first end 862 to the second end 864.

The mixing element 844 is shown with a solid core 846. However, the core 846 could be hollow. A hollow core would be used if a shut-off pin were to extend axially through the core such as illustrated in FIG. 3 above.

Further, the core 846 need not have a circular outer profile and could take other shapes.

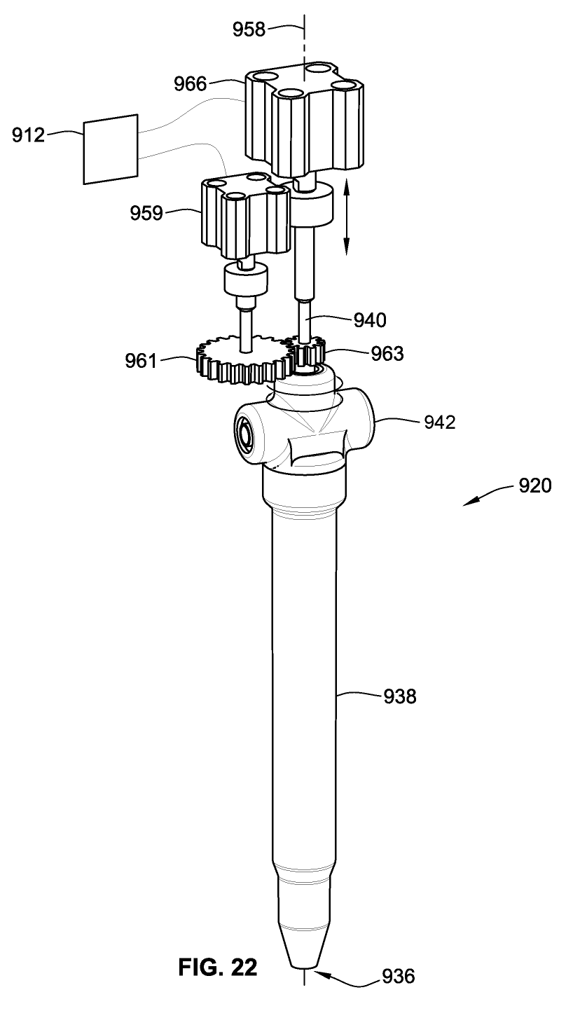

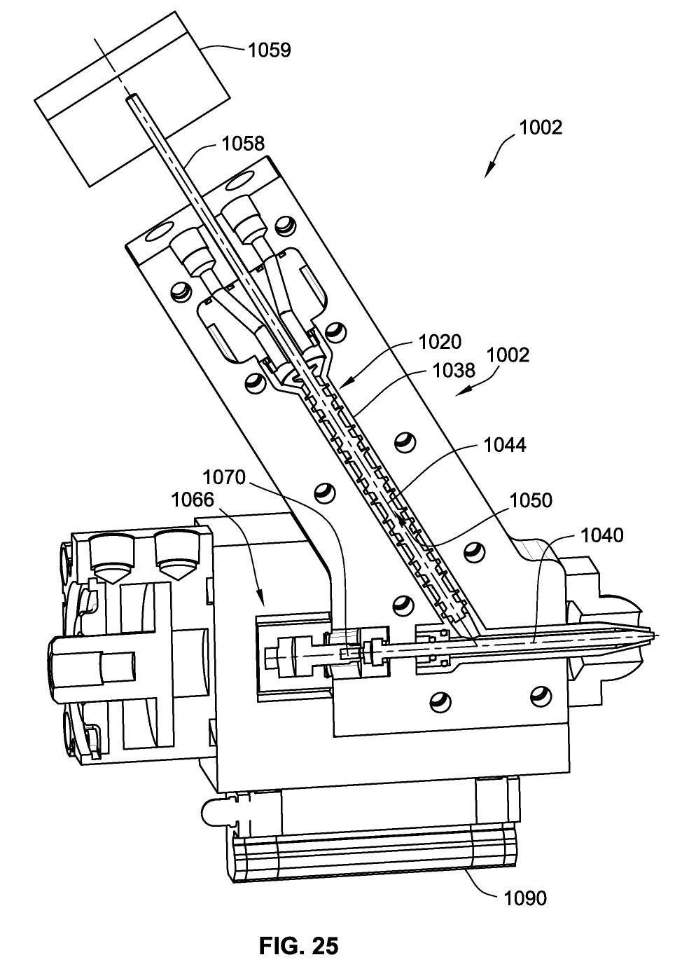

Additionally, while FIG. 20 illustrates a portion of a mixing element, the mixing element 844 could incorporate a shut-off pin directly therein and/or a means for connecting the mixing element 844 to a linear actuator, such as for example actuator 566 as illustrated in FIG. 15, or to a rotational actuator such as actuators 959 or 1059 as illustrated in FIGS. 22 and 25.

FIG. 22 illustrates an embodiment of a mixer assembly in the form of a dynamic mixer assembly 920. While not illustrated, the dynamic mixer assembly 920 could be combined with a mixer holding arrangement similar to static mixer holding arrangements 118 and 218 described above. Further, the different concepts of the dynamic mixer assembly 920 can be incorporated into the multi-material dispensing systems described above.

The dynamic mixer assembly 920 is configured to dynamically mix the materials as they flow through the mixer housing tube 938 as the materials flow from the material manifold 942 to the outlet port 952 and are mixed. The dynamic action of the dynamic mixer assembly 920 can provide for improved mixing capabilities.

Similar to the embodiment of FIGS. 2-5, the dynamic mixer assembly 920 incorporates a co-axial shut-off pin 940 that is driven axially by linear actuator 966 to selectively allow or prevent fluid flow through the outlet port 952. The shut-off pin 940 is slidably carried within a central cavity 951 formed in the center of the mixing element in the form of dynamic mixer 944.

However, unlike the prior embodiment, in this embodiment, the dynamic mixer 944 is configured to be dynamically, rotationally driven about axis 958 by rotational actuator 959. The rotational actuator 959 includes a drive gear 961 that engages and drives driven gear 963.

Driven gear 963 rotates about axis 958 and is mechanically coupled to dynamic mixer 944 to rotationally drive dynamic mixer 944 for rotation about axis 958. In the illustrated embodiment, the driven gear 963 is attached to shaft 965 that extends axially through an end wall of the material manifold 942 that is also connected to a first end 967 of the core 946 of the dynamic mixer 944. In alternative embodiments, shaft 967 and core 946 are a continuous component such as being molded from a single piece of material.

The dynamic mixer 944 will rotate within internal cavity 950 of the mixer housing tube 938.

The shaft 967 is sealed to the material manifold 942 to prevent inadvertent leakage of material.

A controller 912 is operably coupled to actuators 959 and 966 to operably control the actuators 959 and 966 and ultimately the motion of the dynamic mixer 944 and the shut-off pin 940. The controller 912 can be configured to rotate the dynamic mixer 944 in a single direction or oscillate in opposite directions about the central axis 958. Additionally, this controller 912 can be separate from a controller for controlling other components of the overall system or incorporated into that controller.

The mixer housing tube 938, dynamic mixer 944 and shut-off pin 940 are again designed to be disposable and easily replaced as described with regard to prior static mixing embodiments. The driven gear 963 and material manifold 942 may be reusable components or may be included in the disposable components depending on the configuration of the system.

While being illustrated as two separate components, the dynamic mixer 944 and shut-off pin 940 could be formed as a single component in other embodiments. In such an embodiment, the actuator 966 could provide rotational actuation and linear actuation such that driven gear 963 would not be needed. In an alternative embodiment, actuator 966 could be replaced with a rotational actuator and then a second linear actuator could be used to drive the rotational actuator and the combined shut-off pin and dynamic mixer component linearly along a central axis of the shut-off pin and dynamic mixer component.

In some instances, the dynamic mixer 944 is configured such that the dynamic mixer assembly 920 is balanced and provides net zero pumping force. As such, the dynamic mixer assembly still provides for mix on demand operation where the pumping force for pumping the materials through the dynamic mixer assembly 920 as well as dispensing the mixed material is provided by the pumping force provided by the sources of the unmixed materials. At most, the rotational motion of the dynamic mixer 944 will provide 10% of the pumping force and typically will provide less than 5% of the pumping force.

In some embodiments, the alternating direction of the vanes of the dynamic mixer 944 will provide substantially no pumping force because some, typically half, of the vanes will be biasing the material toward outlet port 952 while some, typically half, of the vanes will be biasing the material toward material manifold 942 and away from outlet port 952 such that the overall axially directed force parallel to axis 958 on the material by the rotational motion of the dynamic mixer is zero. In other words, the vanes generally balance themselves out such that no pumping force is provided by the motion of the dynamic mixer 944.

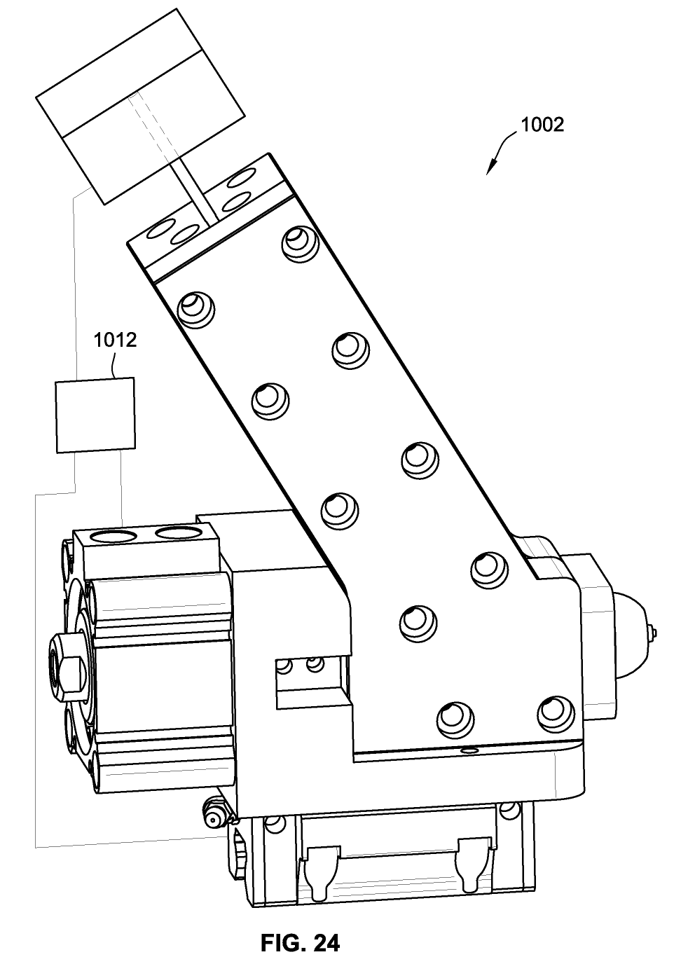

FIGS. 24 and 25 illustrate a further embodiment of a dispensing and mixing unit 1002 that could be incorporated into multi-material dispensing systems and may be attached to the various heat transfer units and sources of material as described in those systems.

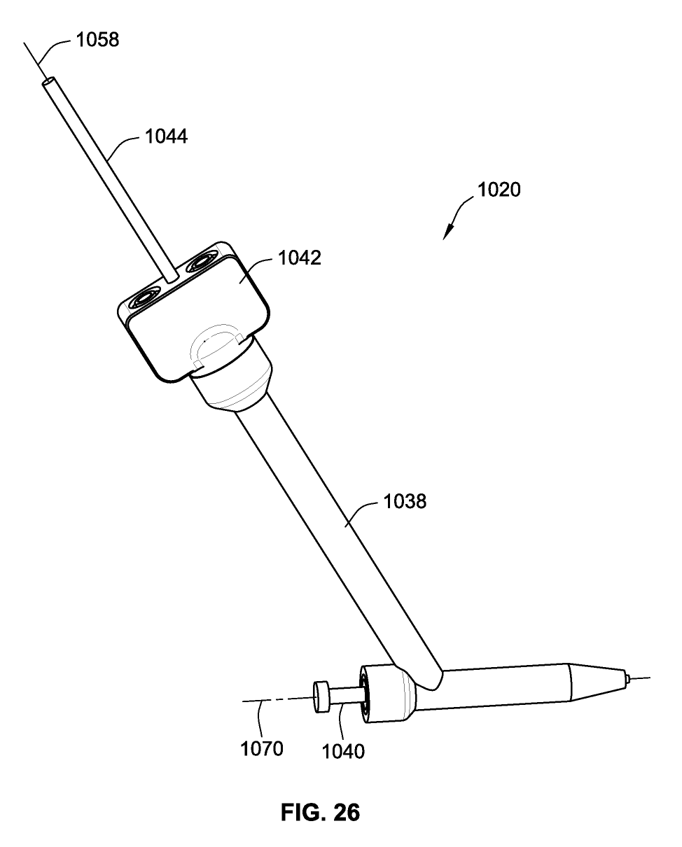

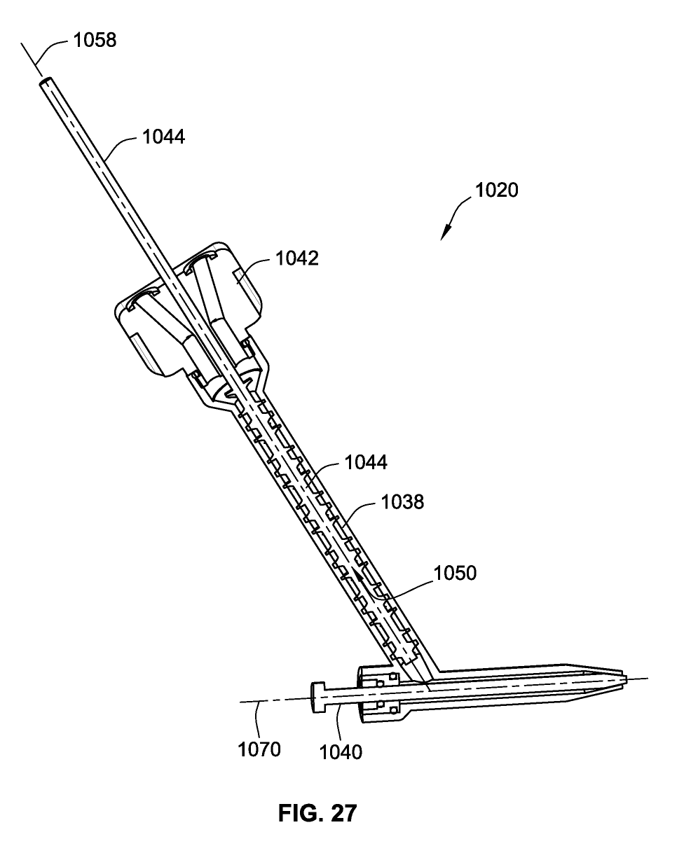

This dispensing and mixing unit 1002 includes a dynamic mixer assembly 1020, further illustrated in FIGS. 26 and 27, that provides for dynamic mixing of the materials being mixed similar to the dynamic mixer assembly 920 described above. However, this embodiment is similar to the static mixer assemblies 320, 420 of FIGS. 12-14 in that the shut-off pin 1040 and dynamic mixer 1044 are not coaxial.

In this embodiment, the shut-off pin 1040 does not extend through the mixing region of the internal cavity 1050 of the mixer housing tube 1038 and particularly through the mixing element in the form of dynamic mixer 1044. Instead, the shut-off pin 1040 is located downstream from the dynamic mixer 1044 and is located only in the dispensing region of the internal cavity 1050. In this embodiment the shut-off pin 1040 is actuated along a drive axis 1070 that is non-parallel to the longitudinal axis 1058 generally defined by the dynamic mixer 1044. Further, the shut-off pin 1040 is entirely downstream of the dynamic mixer 1044.

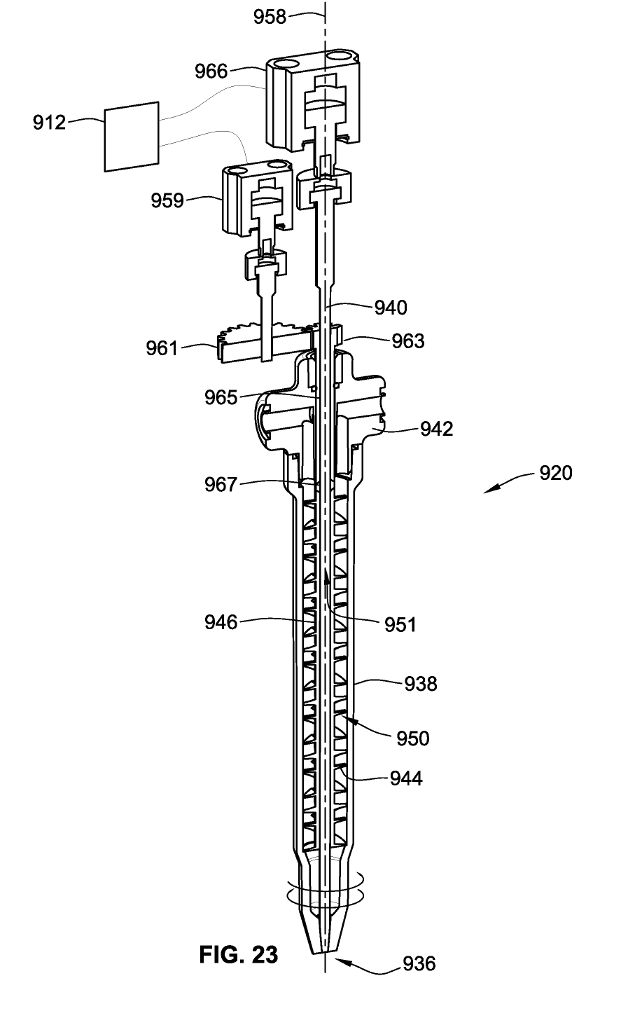

Like the embodiment of FIGS. 22-23, the dynamic mixer assembly 1020 allows for dynamically rotating the dynamic mixer 1044 about axis 1058. Actuator 1059 is attached to dynamic mixer 1044 to operably rotationally drive the dynamic mixer 1044. Linear actuator 1066 is operably coupled to the shut-off pin 1040 to drive the shut-off pin 1040 linearly between open and closed positions along axis 1070. A further linear actuator 1090 is configured to operably drive the dynamic mixer assembly 1020 into and out of engagement with a mold set. Actuator 1090 will typically provide linear motion parallel to axis 1070 but could provide motion along a different axis.

Similar to the embodiment of FIGS. 22 and 23, this embodiment can also operate as a mix on demand system where the dynamic mixer 1044 provides substantially no (e.g. less than 10% and preferably less than 5% and preferably substantially 0%) of the pumping force to dispense the mixed product from the dynamic mixer assembly 1020.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A mixer assembly comprising:
a mixer housing tube extending axially between an inlet end and an outlet end, the mixer housing tube defining an internal cavity, the outlet end of the mixer housing tube having an outlet port defining a sealing surface, the outlet port fluidly communicating the internal cavity with the exterior of the mixer housing tube;
a shut-off pin within the mixer housing tube, the shut-off pin being selectively moveable between an open position and a closed position, the shut-off pin cooperating with the sealing surface of the outlet port to close the outlet port in the closed position, the shut-off pin being spaced from the sealing surface of the outlet port in the open position to permit fluid flow through the outlet port;
a material manifold proximate the inlet end of the mixer housing tube including a first material inlet in fluid communication with the internal cavity and a second material inlet in fluid communication with the internal cavity; and
a mixer element located within the internal cavity of the mixer housing tube between the outlet port and the material manifold, the mixer element and mixer housing tube forming a mixing passage fluidly connecting the first and second material inlets with the outlet port.

2. The mixer assembly of claim 1, wherein the shut-off pin extends through the mixer element.

3. (canceled)

4. The mixer assembly of claim 1, wherein the shut-off pin includes a connection head configured to be releasably connected to an actuator for actuation of the shut-off pin between the closed and open positions.

5. (canceled)

6. The mixer assembly of claim 1, wherein the mixer housing tube, shut-off pin, material manifold and mixer element form a disposable unit.

7-10. (canceled)

11. The mixer assembly of claim 1, wherein the shut-off pin and mixer element are formed as a single component and the mixer element moves when the shut-off pin moves between the open and closed positions.

12-13. (canceled)

14. A multiple material dispensing system comprising:
a first mixer assembly according to claim 1;
a mixer holding arrangement defining a mixer element holding cavity in which the first mixer assembly is mounted;
an actuator releasably connected to the shut-off pin for actuation of the shut-off pin between the open and closed positions;
a source of a first material operably releasably connected to the first material inlet; and
a source of a second material operably releasably connected to the first material inlet.

15. The multiple material dispensing system of claim 14, wherein the mixer element, the mixer housing tube and shut-off pin are removable from the mixer holding arrangement as a complete unit.

16. (canceled)

17. The multiple material dispensing system of claim 14, wherein the mixer holding arrangement is a holding body defining at least one heat transfer passage therethrough configured to flow a cooling or heating liquid to provide heat to or remove heat from the mixer element while material is dispensed therefrom.

18-20. (canceled)

21. The multiple material dispensing system of claim 14, wherein the mixer holding arrangement includes a first holding body portion, a second holding body portion and a nozzle, the nozzle and second holding body portion being releasably attached to the first holding body to allow for removal of the first mixer assembly from the mixer holding cavity; and
further comprising a mold defining a mold port, the nozzle configured to mate with the mold port when material is injected into the mold from the mixer assembly.

22-32. (canceled)

33. A method of dispensing a multi-component material from a multiple material dispensing system comprising:
supplying a first material from a source of a first material to a first mixer assembly;
supplying a second material from a source of a second to the first mixer assembly;
mixing the first and second materials with the first mixer assembly to form a mixed material;
dispensing the mixed material from the first mixer assembly through an outlet port of the first mixer assembly;
actuating a shut-off pin of the first mixer assembly between an open position and a closed position, the shut-off pin cooperating with a sealing surface of the outlet port to close the outlet port in the closed position, the shut-off pin being spaced from the sealing surface of the outlet port in the open position to permit fluid flow through the outlet port.

34. The method of claim 33, further comprising replacing the first mixer assembly with a second mixer assembly.

35. The method of claim 34, wherein each of the first and second mixer assemblies further includes:
a mixer housing tube extending axially between an inlet end and an outlet end, the mixer housing tube defining an internal cavity, the outlet end of the mixer housing tube including the outlet port, the outlet port fluidly communicating the internal cavity with the exterior of the mixer housing tube, the shut-off pin is within the mixer housing tube;
a material manifold proximate the inlet end of the mixer housing tube including a first material inlet in fluid communication with the internal cavity and a second material inlet in fluid communication with the internal cavity; and
a mixer element located within the internal cavity of the mixer housing tube between the outlet port and the material manifold, the mixer element forming a mixing passage fluidly connecting the first and second material inlets with the outlet port.

36-52. (canceled)

53. A mix on demand multiple material dispensing system comprising:
a first mixer assembly including:
a mixer housing tube extending axially between an inlet end and an outlet end, the mixer housing tube defining an internal cavity, the outlet end of the mixer housing tube having an outlet port, the outlet port fluidly communicating the internal cavity with the exterior of the mixer housing tube;
a material manifold proximate the inlet end of the mixer housing tube including a first material inlet in fluid communication with the internal cavity and a second material inlet in fluid communication with the internal cavity; and
a mixer element located within the internal cavity of the mixer housing tube between the outlet port and the material manifold, the mixer element and mixer housing tube forming a mixing passage fluidly connecting the first and second material inlets with the outlet port for mixing fluids flowing from the first and second material inlets to the outlet port;
a source of a first material including:
a first storage reservoir for holding a first material;
a first pumping assembly operably connected to the first material inlet and configured to pump a first material into the first material inlet; and
a source of a second material including:
a second storage reservoir for holding a first material;
a second pumping assembly operably connected to the second material inlet and configured to pump a second material into the second material inlet; and
wherein the first and second pumping assemblies pump the first and second materials into and through the material manifold, mixer housing tube and through the mixer element.

54. The multiple material dispensing system of claim 53, further comprising a mold defining a mold cavity in fluid communication with the outlet port of the mixer assembly, wherein the first and second pumping assemblies pump the first and second materials into the material manifold, through the mixer element, the mixer housing tube and into the mold cavity.

55-57. (canceled)

58. The multiple material dispensing system of claim 53, further comprising a shut-off pin within the mixer housing tube, the shut-off pin being selectively moveable between an open position and a closed position, the shut-off pin cooperating with the sealing surface of the outlet port to close the outlet port in the closed position, the shut-off pin being spaced from the sealing surface of the outlet port in the open position to permit fluid flow through the outlet port.

59. The multiple material dispensing system of claim 58, further comprising a mold defining a mold cavity in fluid communication with the outlet port of the mixer assembly, wherein the first and second pumping assemblies pump the first and second materials into the material manifold, through the mixer housing tube, mixer element and into the mold cavity, further comprising an actuation arrangement configured to selectively engage and disengage the mixer assembly from the mold to reduce heat transfer between the mold and the mixer assembly.

60-103. (canceled)
